(19) United States
(12) Patent Application Publication
(10) Pub. No.: US 2025/0294389 A1
(43) Pub. Date: Sep. 18, 2025

(54) Terminal Device, Peer-To-Peer Communication Method, and Communication System

(71) Applicant: Huawei Technologies Co., Ltd., Shenzhen (CN)

(72) Inventors: Jian Jiang, Shanghai (CN); Jingjing Yao, Shanghai (CN); Shangbang Sun, Shanghai (CN); Jikang Xia, Shenzhen (CN)

(21) Appl. No.: 19/221,872

(22) Filed: May 29, 2025

Related U.S. Application Data
(63) Continuation of application No. PCT/CN2023/127617, filed on Oct. 30, 2023.

(30) Foreign Application Priority Data
Nov. 30, 2022 (CN) 202211529165.9

(51) Int. Cl. H04W 24/08; H04W 74/0816; H04W 76/10; H04W 76/30

(52) U.S. Cl. CPC H04W 24/08; H04W 74/0816; H04W 76/10; H04W 76/30

(57) ABSTRACT

A terminal device includes a radio frequency control circuit adapted to configure a first path to operate on a first channel and a second path to operate on a second channel. A baseband receiving circuit is configured to monitor the first channel, and send monitoring information of the first channel to a channel monitoring and switching circuit. The channel monitoring and switching circuit is configured to monitor the second channel, and when a service packet is to be transmitted, establish a connection between the radio frequency circuit and the baseband receiving circuit on the second path, based on the monitoring information of the first channel and monitoring information of the second channel, and send a first notification to the radio frequency control circuit.

### CROSS-REFERENCE TO RELATED APPLICATIONS

This is a continuation of International Patent Application No. PCT/CN2023/127617, filed on Oct. 30, 2023, which claims priority to Chinese Patent Application No. 202211529165.9, filed on Nov. 30, 2022. The disclosures of the aforementioned applications are hereby incorporated by reference in their entireties.

### TECHNICAL FIELD

This disclosure relates to the field of communication technologies, and in particular, to a terminal device, a peer-to-peer (P2P) communication method, and a communication system.

### BACKGROUND

Wireless fidelity (Wi-Fi) P2P is an important technical specification launched by the Wi-Fi alliance in a Wi-Fi technology. Wi-Fi P2P still supports interconnection and high-speed data transmission between terminal devices without a local area network or the Internet.

Based on this, delay-sensitive services, such as wireless projection, multi-screen collaboration, multi-device interaction, industrial control, an augmented reality (AR) technology, and a virtual reality (VR) technology that have a high delay requirement, can be borne between terminal devices supporting Wi-Fi P2P. For example, in a projection scenario with 1080p (pixel) resolution and 60 frames per second, a delay jitter is required not to exceed 16 milliseconds (ms). Otherwise, a frame rate for projection is decreased, affecting projection quality.

Therefore, when the delay-sensitive services are executed between the terminal devices supporting Wi-Fi P2P, how to make service transmission keep a stable low delay is an urgent problem that needs to be resolved currently.

### SUMMARY

This disclosure provides a terminal device, a peer-to-peer communication method, and a communication system, to ensure that a service transmission delay is stable at a low level, also guarantee service experience of a device, and maintain a communication specification of the device without increasing radio frequency costs of the device.

According to a first aspect, this disclosure provides a terminal device, including a first antenna, a second antenna, a radio frequency circuit, a channel monitoring and switching circuit, a baseband receiving circuit, and a radio frequency control circuit.

The radio frequency circuit is separately connected to the first antenna and the baseband receiving circuit, the first antenna, the radio frequency circuit, and the baseband receiving circuit form a first path, the radio frequency circuit is further separately connected to the second antenna and the channel monitoring and switching circuit, the second antenna, the radio frequency circuit, and the channel monitoring and switching circuit form a second path, the channel monitoring and switching circuit is further connected to the baseband receiving circuit, and the radio frequency control circuit is connected to the radio frequency circuit and the channel monitoring and switching circuit.

The radio frequency control circuit is configured to configure, through the radio frequency circuit, configure the first path to operate on a first channel and the second path to operate on a second channel.

The baseband receiving circuit is configured to monitor the first channel, and send monitoring information of the first channel to the channel monitoring and switching circuit.

The channel monitoring and switching circuit is configured to monitor the second channel.

The channel monitoring and switching circuit is further configured to: when it is determined that a service packet needs to be transmitted, establish a connection between the radio frequency circuit and the baseband receiving circuit on the second path based on the monitoring information of the first channel and monitoring information of the second channel, and send a first notification to the radio frequency control circuit.

The radio frequency control circuit is further configured to configure, based on the first notification through the radio frequency circuit, both the first path and the second path to operate on a target channel, where the target channel is the first channel or the second channel.

The first antenna and the second antenna are configured to perform transmission of a service packet with another terminal device on the target channel.

According to the terminal device in the first aspect, the radio frequency control circuit may configure the radio frequency circuit on the first path to operate on the first channel, and configure the radio frequency circuit on the second path to operate on the second channel, so that the terminal device can simultaneously use respective Wi-Fi P2P connections on the two channels. The baseband receiving circuit may monitor the first channel, and the channel monitoring and switching circuit may monitor the second channel, so that the two paths in the terminal device can simultaneously perform channel contention, channel access, and channel use on the two channels.

The baseband receiving circuit may send the monitoring information of the first channel to the channel monitoring and switching circuit. When it is determined that the service packet needs to be transmitted, the channel monitoring and switching circuit may establish the connection between the radio frequency circuit and the baseband receiving circuit on the second path based on the monitoring information of the first channel and the monitoring information of the second channel, and send the first notification to the radio frequency control circuit. The radio frequency control circuit may configure, based on the first notification, the radio frequency circuit on the first path and the second path to operate on the target channel, where the target channel is the first channel or the second channel, so that the terminal device can use two identical Wi-Fi P2P connections on a same channel. The first antenna and the second antenna may perform transmission of the service packet with the another terminal device on the target channel.

Therefore, when a baseband side circuit is not added to the terminal device, the two paths can simultaneously operate on the two different channels, so that the terminal device can have a multi-radio frequency multi-link capability. In addition, when a radio frequency capability of the terminal device remains undiminished, the two paths can simultaneously operate on the same channel, so that the terminal device can have a single radio frequency multi-link capability, to provide a stable low-delay transmission capability for a delay-sensitive service. In this way, radio frequency costs of the terminal device are reduced.

In a possible design, the baseband receiving circuit is further configured to send a second notification to the channel monitoring and switching circuit when transmission of the service packet ends.

The channel monitoring and switching circuit is further configured to break the connection between the radio frequency circuit and the baseband receiving circuit on the second path based on the second notification, and send a third notification to the radio frequency control circuit.

The radio frequency control circuit is further configured to configure, based on the third notification through the radio frequency circuit, the first path to operate on the first channel and the second path to operate on the second channel.

Therefore, after transmission of the service packet ends, the connection between the baseband receiving circuit and the radio frequency circuit on the second path is broken, so that the terminal device is restored to a channel monitoring phase, that is, the baseband receiving circuit continues to monitor the first channel, and the channel monitoring and switching circuit continues to monitor the second channel, so that the two paths in the terminal device can perform channel contention on the two channels, to prepare for channel access and channel use.

In a possible design, when the target channel is the first channel, the radio frequency control circuit is configured to configure the first path to continue to operate on the first channel, and configure the second path to switch to operate on the first channel.

Alternatively, when the target channel is the second channel, the radio frequency control circuit is configured to configure the first path to switch to operate on the second channel, and configure the second path to continue to operate on the second channel.

In a possible design, the channel monitoring and switching circuit is configured to determine a channel in an idle state as the target channel based on the monitoring information of the first channel and the monitoring information of the second channel.

An antenna corresponding to the target channel is configured to send a request to send (RTS) control frame to the another terminal device on the target channel, where the antenna corresponding to the target channel is the first antenna or the second antenna.

The channel monitoring and switching circuit is configured to establish the connection between the radio frequency circuit and the baseband receiving circuit on the second path, and send the first notification to the radio frequency control circuit.

The radio frequency control circuit is configured to configure, based on the first notification through the radio frequency circuit, both the first path and the second path to operate on the target channel.

The first antenna and the second antenna are configured to: after the baseband receiving circuit receives a clear to send control frame sent by the another terminal device, send a service packet to the another terminal device on the target channel.

Therefore, the terminal device may use the channel in the idle state in the first channel and the second channel as the target channel, to provide a possible implementation for determining the target channel. In this way, the two paths in the terminal device simultaneously send service packets to the another terminal device on the same channel.

In a possible design, the channel monitoring and switching circuit is configured to: when determining, based on the monitoring information of the first channel and the monitoring information of the second channel, that a received first RTS control frame does not point to the terminal device, determine a channel other than a channel for the first RTS control frame in the first channel and the second channel as the target channel.

An antenna corresponding to the target channel is configured to send a second RTS control frame to the another terminal device on the target channel, where the antenna corresponding to the target channel is the first antenna or the second antenna.

The channel monitoring and switching circuit is configured to establish the connection between the radio frequency circuit and the baseband receiving circuit on the second path, and send the first notification to the radio frequency control circuit.

The radio frequency control circuit is configured to configure, based on the first notification through the radio frequency circuit, both the first path and the second path to operate on the target channel.

The first antenna and the second antenna are configured to: after the baseband receiving circuit receives a clear to send control frame sent by the another terminal device, send a service packet to the another terminal device on the target channel.

Therefore, when the another terminal device requests to receive a service packet from another terminal device, the terminal device may use a channel other than a channel for transmitting the request in the first channel and the second channel as the target channel, to provide a possible implementation for determining the target channel. In this way, the two paths in the terminal device simultaneously send a service packet to the another terminal device on the same channel.

In a possible design, the channel monitoring and switching circuit is configured to: when determining, based on the monitoring information of the first channel and the monitoring information of the second channel, that the received RTS control frame points to the terminal device, determine a channel for the RTS control frame as the target channel.

The channel monitoring and switching circuit is configured to establish the connection between the radio frequency circuit and the baseband receiving circuit on the second path, and send the first notification to the radio frequency control circuit.

The radio frequency control circuit is configured to configure, based on the first notification through the radio frequency circuit, both the first path and the second path to operate on the target channel.

The first antenna and the second antenna are configured to send a clear to send control frame to the another terminal device on the target channel, and after sending the clear to send control frame, receive, on the target channel, a service packet sent by the another terminal device.

Therefore, when the another terminal device requests the terminal device to receive a service packet, the terminal device may use a channel for transmitting the request in the first channel and the second channel as the target channel, to provide a possible implementation for determining the target channel. In this way, the two paths in the terminal device simultaneously receive the service packet from the another terminal device on the same channel.

In a possible design, the terminal device further includes a first analog-to-digital converter (ADC), a second ADC, a first digital-to-analog converter (DAC), a second DAC, and a baseband sending circuit.

The radio frequency circuit is further separately connected to the first ADC and the first DAC on the first path, the radio frequency circuit is further separately connected to the second ADC and the second DAC on the second path, the first ADC is further connected to the baseband receiving circuit, the second ADC is further connected to the channel monitoring and switching circuit, the channel monitoring and switching circuit is further connected to the baseband sending circuit, and the baseband sending circuit is further separately connected to the first DAC and the second DAC.

Therefore, a composition structure of the terminal device can be enriched, and sufficient and reliable hardware circuits are provided for transmission of the service packet.

In a possible design, the channel monitoring and switching circuit includes a switching switch, a monitoring circuit, and a single radio frequency multi-link control circuit.

A first end of the switching switch is connected to the second ADC, a first contact point of the switching switch is connected to the baseband receiving circuit, a second contact point of the switching switch is connected to a first end of the monitoring circuit, a control end of the switching switch is connected to a first end of the single radio frequency multi-link control circuit, a second end of the monitoring circuit is connected to a second end of the single radio frequency multi-link control circuit, a third end of the single radio frequency multi-link control circuit is connected to the radio frequency control circuit, a fourth end of the single radio frequency multi-link control circuit is connected to the baseband receiving circuit, and a fifth end of the single radio frequency multi-link control circuit is connected to the baseband sending circuit.

The single radio frequency multi-link control circuit is configured to control the switching switch to: break the connection between the radio frequency circuit and the baseband receiving circuit on the second path, and establish a connection between the radio frequency circuit and the monitoring circuit on the second path.

The single radio frequency multi-link control circuit is further configured to receive the monitoring information of the first channel sent by the baseband receiving circuit.

The monitoring circuit is configured to monitor the second channel, and send the monitoring information of the second channel to the single radio frequency multi-link control circuit.

The single radio frequency multi-link control circuit is further configured to determine the target channel based on the monitoring information of the first channel and the monitoring information of the second channel.

The single radio frequency multi-link control circuit is further configured to control the switching switch to: establish the connection between the radio frequency circuit and the baseband receiving circuit on the second path, and break the connection between the radio frequency circuit and the monitoring circuit on the second path, and send the first notification to the radio frequency control circuit.

Therefore, the channel monitoring and switching circuit may be divided into a plurality of circuits based on functions, to provide a possible implementation for the channel monitoring and switching circuit.

In a possible design, the single radio frequency multi-link control circuit is further configured to receive the second notification sent by the baseband receiving circuit.

The single radio frequency multi-link control circuit is configured to control, based on the second notification, the switching switch to break the connection between the radio frequency circuit and the baseband receiving circuit on the second path, establish the connection between the radio frequency circuit and the monitoring circuit on the second path, and send the third notification to the radio frequency control circuit, where the third notification is used by the radio frequency control circuit to configure, through the radio frequency circuit, the first path to operate on the first channel and the second path to operate on the second channel.

In a possible design, the radio frequency circuit includes a first radio frequency front end circuit, a first frequency conversion circuit, a second radio frequency front end circuit, a second frequency conversion circuit, a first phase-locked loop circuit, and a second phase-locked loop circuit.

The first antenna is connected to a common end of the first radio frequency front end circuit, a first end of the first radio frequency front end circuit is connected to a first end of the first frequency conversion circuit, a second end of the first frequency conversion circuit is connected to a first end of the first ADC, a second end of the first ADC is connected to a first end of the baseband receiving module, a first end of the baseband sending module is connected to a first end of the first DAC, and a second end of the first DAC is connected to a third end of the first frequency conversion circuit.

A fourth end of the first frequency conversion circuit is connected to the first phase-locked loop circuit, a fifth end of the first frequency conversion circuit is connected to the second phase-locked loop circuit, and a sixth end of the first frequency conversion circuit is connected to a second end of the radio frequency control circuit.

The second antenna is connected to a common end of the second radio frequency front end circuit, a first end of the second radio frequency front end circuit is connected to a first end of the second frequency conversion circuit, a second end of the second frequency conversion circuit is connected to a first end of the second ADC, a second end of the second ADC is connected to the first end of the switching switch, a second end of the baseband sending circuit is connected to a first end of the second DAC, and a second end of the second DAC is connected to a third end of the second frequency conversion circuit.

A fourth end of the second frequency conversion circuit is connected to the second phase-locked loop circuit, a fifth end of the second frequency conversion circuit is connected to the first phase-locked loop circuit, and a sixth end of the second frequency conversion circuit is connected to a third end of the radio frequency control circuit.

The first contact point of the switching switch is connected to a second end of the baseband receiving circuit, the fourth end of the single radio frequency multi-link control circuit is connected to a third end of the baseband receiving circuit, and the fifth end of the single radio frequency multi-link control circuit is connected to a third end of the baseband sending circuit.

In a possible design, the first channel and the second channel are two channels in a same band or two channels in different bands.

In a possible design, the first channel and the second channel are any one of a channel in a 2.4 gigahertz (G) band and a channel in the 2.4G band, a channel in a 5G band and a channel in the 5G band, a channel in a 6G band and a channel in the 6G band, a channel in a 2.4G band and a channel in a 5G band, a channel in a 2.4G band and a channel in a 6G band, or a channel in a 5G band and a channel in a 6G band.

Therefore, the channels corresponding to the two paths in the terminal device can be flexibly combined in various bands, so that the terminal device can consider application scenarios and user requirements of the various bands.

According to a second aspect, this disclosure provides a peer-to-peer communication method, applied to a terminal device, where the terminal device includes a first antenna, a second antenna, a radio frequency circuit, a channel monitoring and switching circuit, a baseband receiving circuit, and a radio frequency control circuit.

The radio frequency circuit is separately connected to the first antenna and the baseband receiving circuit, the first antenna, the radio frequency circuit, and the baseband receiving circuit form a first path, the radio frequency circuit is further separately connected to the second antenna and the channel monitoring and switching circuit, the second antenna, the radio frequency circuit, and the channel monitoring and switching circuit form a second path, the channel monitoring and switching circuit is further connected to the baseband receiving circuit, and the radio frequency control circuit is connected to the radio frequency circuit and the channel monitoring and switching circuit.

The method includes:

The radio frequency control circuit configures, through the radio frequency circuit, the first path to operate on a first channel and the second path to operate on a second channel.

The baseband receiving circuit monitors the first channel, and sends monitoring information of the first channel to the channel monitoring and switching circuit.

The channel monitoring and switching circuit monitors the second channel.

When it is determined that a service packet needs to be transmitted, the channel monitoring and switching circuit establishes a connection between the radio frequency circuit and the baseband receiving circuit on the second path based on the monitoring information of the first channel and monitoring information of the second channel, and sends a first notification to the radio frequency control circuit.

The radio frequency control circuit configures, based on the first notification through the radio frequency circuit, both the first path and the second path to operate on a target channel, where the target channel is the first channel or the second channel.

The first antenna and the second antenna perform transmission of a service packet with another terminal device on the target channel.

In a possible design, the method further includes:

The baseband receiving circuit sends a second notification to the channel monitoring and switching circuit when transmission of the service packet ends.

The channel monitoring and switching circuit breaks the connection between the radio frequency circuit and the baseband receiving circuit on the second path based on the second notification, and sends a third notification to the radio frequency control circuit.

The radio frequency control circuit configures, based on the third notification through the radio frequency circuit, the first path to operate on the first channel and the second path to operate on the second channel.

In a possible design, the method includes:

The channel monitoring and switching circuit determines a channel in an idle state as the target channel based on the monitoring information of the first channel and the monitoring information of the second channel.

An antenna corresponding to the target channel sends a RTS control frame to the another terminal device on the target channel, where the antenna corresponding to the target channel is the first antenna or the second antenna.

The channel monitoring and switching circuit establishes the connection between the radio frequency circuit and the baseband receiving circuit on the second path, and sends the first notification to the radio frequency control circuit.

The radio frequency control circuit configures, based on the first notification through the radio frequency circuit, both the first path and the second path to operate on the target channel.

After the baseband receiving circuit receives a clear to send control frame sent by the another terminal device, the first antenna and the second antenna send a service packet to the another terminal device on the target channel.

In a possible design, the method includes:

When determining, based on the monitoring information of the first channel and the monitoring information of the second channel, that a received first RTS control frame does not point to the terminal device, the channel monitoring and switching circuit determines a channel other than a channel for the first RTS control frame in the first channel and the second channel as the target channel.

An antenna corresponding to the target channel sends a second RTS control frame to the another terminal device on the target channel, where the antenna corresponding to the target channel is the first antenna or the second antenna.

The channel monitoring and switching circuit establishes the connection between the radio frequency circuit and the baseband receiving circuit on the second path, and sends the first notification to the radio frequency control circuit.

The radio frequency control circuit configures, based on the first notification through the radio frequency circuit, both the first path and the second path to operate on the target channel.

After the baseband receiving circuit receives a clear to send control frame sent by the another terminal device, the first antenna and the second antenna send a service packet to the another terminal device on the target channel.

In a possible design, the method includes:

When determining, based on the monitoring information of the first channel and the monitoring information of the second channel, that the received RTS control frame points to the terminal device, the channel monitoring and switching circuit determines a channel for the RTS control frame as the target channel.

The channel monitoring and switching circuit establishes the connection between the radio frequency circuit and the baseband receiving circuit on the second path, and sends the first notification to the radio frequency control circuit.

The radio frequency control circuit configures, based on the first notification through the radio frequency circuit, both the first path and the second path to operate on the target channel.

The first antenna and the second antenna send a clear to send control frame to the another terminal device on the target channel, and after sending the clear to send control frame, receive, on the target channel, a service packet sent by the another terminal device.

For beneficial effects of the peer-to-peer communication method provided in the second aspect and the possible designs of the second aspect, refer to the beneficial effects brought by the first aspect and the possible implementations of the first aspect. Details are not described herein again.

According to a third aspect, this disclosure provides a communication system, including a plurality of terminal devices in the first aspect and the possible implementations of the first aspect.

### BRIEF DESCRIPTION OF DRAWINGS

FIG. 1 is a diagram of an architecture of a communication system according to an embodiment;

FIG. 2 is a diagram of a structure of a terminal device according to an embodiment;

FIG. 3A is a diagram of a P2P communication method according to an embodiment;

FIG. 3B is a diagram of a service packet transmission scenario of a terminal device according to an embodiment;

FIG. 4 is a diagram of executing a delay-sensitive service by a terminal device;

FIG. 5 is a diagram of a structure of a terminal device according to an embodiment;

FIG. 6 is a diagram of connections of circuits of a terminal device in a channel monitoring phase according to an embodiment;

FIG. 7 is a diagram of connections of circuits of a terminal device in a service transmission phase according to an embodiment;

FIG. 8A and FIG. 8B are diagrams of a P2P communication method according to an embodiment;

FIG. 9 is a diagram of a service packet transmission scenario of a terminal device according to an embodiment;

FIG. 10A and FIG. 10B are diagrams of a P2P communication method according to an embodiment;

FIG. 11 is a diagram of a service packet transmission scenario of a terminal device according to an embodiment;

FIG. 12A and FIG. 12B are diagrams of a P2P communication method according to an embodiment; and

FIG. 13 is a diagram of a service packet transmission scenario of a terminal device according to an embodiment.

### DESCRIPTION OF EMBODIMENTS

In this disclosure, “at least one” means one or more, and “a plurality of” means two or more. The term “and/or” describes an association relationship between associated objects, and represents that three relationships may exist. For example, A and/or B may represent the following cases: Only A exists, both A and B exist, and only B exists, where A and B may be singular or plural. The character “/” generally indicates an “or” relationship between the associated objects. “At least one of the following items (pieces)” or a similar expression thereof refers to any combination of these items, including any combination of singular items (pieces) or plural items (pieces). For example, at least one of a, b, or c may represent: a, b, c, a combination of a and b, a combination of a and c, a combination of b and c, or a combination of a, b, and c, where each of a, b, and c may be in a singular form or a plural form.

In addition, unless otherwise expressly specified and limited, the term “connection” should be understood in a broad sense. For example, the “connection” may be a fixed connection, a detachable connection, or an integrated connection, or may be a direct connection or an indirect connection implemented through an intermediate medium. Terms “first” and “second” are merely used for a purpose of description, and shall not be understood as an indication or implication of relative importance. An orientation or a location relationship indicated by term such as “center”, “vertical”, “horizontal”, “up”, “down”, “left”, “right”, “front”, or “back” is based on an orientation or a location relationship shown in the accompanying drawings, and is merely intended to facilitate description of this disclosure and simplify description, but does not indicate or imply that a specified apparatus or element needs to have a specific orientation and be constructed and operated in a specific orientation. Therefore, such terms should not be construed as limitations to this disclosure.

When a user initiates a service, a Wi-Fi P2P connection may be established between terminal devices supporting Wi-Fi P2P. After the Wi-Fi P2P connection is established, an upper-layer Transmission Control Protocol (TCP)/User Datagram Protocol (UDP) connection is established between the terminal devices, so that the terminal devices can perform data communication through the TCP/UDP connection, that is, the terminal devices can perform data communication in a Wi-Fi P2P manner.

Therefore, the terminal device supporting Wi-Fi P2P may discover surrounding another terminal device supporting Wi-Fi P2P, and may perform high-speed data transmission with the discovered another terminal device through the Wi-Fi P2P connection without a hotspot or a router.

For example, a projection function, a Wi-Fi direct-connection function, an instant sharing function (for example, a HUAWEI share function of a mobile phone), and the like of the terminal device may implement data communication by establishing the Wi-Fi P2P connection to the another terminal device. When the user wants to use these functions, the user may perform a corresponding operation in a corresponding interface, for example, perform an operation on a corresponding button, to trigger the terminal device to discover the surrounding another terminal device, and perform data communication with the discovered terminal device through the Wi-Fi P2P connection, for example, implement a delay-sensitive service.

The following describes several related technologies for implementing the delay-sensitive service between terminal devices supporting Wi-Fi P2P.

In a related technology 1, terminal devices are increasingly dense, and consequently service channels are increasingly congested. To enable each terminal device to fairly use a channel, a carrier sense multiple access/collision avoidance (CSMA/CA) mechanism is designed. In this mechanism, when sending a service packet, each terminal device needs to monitor a channel. Once the channel is congested/busy, the terminal device needs to wait until the channel is idle before occupying the channel to send the service packet.

It can be learned that each terminal device uses one channel, and can send the service packet each time the terminal device needs to wait until the channel is idle. In this way, when the terminal device executes the delay-sensitive service, a delay is not stable enough, and a frame freezing phenomenon easily occurs. When there are a large quantity of terminal devices on a same channel, channel congestion is caused, and delay duration is prolonged.

In a related technology 2, a terminal device may simultaneously operate on two channels. A channel in a 2.4G band and a channel in a 5G band are used as an example. The terminal device may establish a Wi-Fi P2P connection on the channel in the 2.4G band, and establish a Wi-Fi P2P connection on the channel in the 5G band. Therefore, when sending a service packet, the terminal device may monitor the two channels, and once one channel is idle, the terminal device may occupy the channel to send the service packet.

It can be learned that each terminal device uses two channels, and selects an idle channel from the two channels to send the service packet. In this way, the terminal device needs to have two independent radio frequency baseband circuits, and each channel can implement sending and receiving of a 2×2 multiple input multiple output (MIMO) capability, but radio frequency costs of the device are increased; or the terminal device needs a radio frequency baseband circuit that can simultaneously operate on two channels, and each channel can implement only 1×1 single input single output (SISO). Consequently, a radio frequency capability of the device is reduced, and a delay-sensitive service may not be carried.

In a related technology 3, in a wireless communication system, a communication link may be established between a wireless access point (AP) and a non-access point (non-AP) station (STA) on multiple channels. When a service packet is sent, two links are simultaneously monitored, and once one link is idle, the service packet may be sent. Therefore, a terminal device supporting Wi-Fi P2P is used as a STA device, and the STA device needs to perform channel switching through scheduling of the AP device. To be specific, the AP device selects an operating channel, and sends a multi-user RTS (MU-RTS) trigger frame on the channel. The STA device receives the MU-RTS trigger frame, and is controlled to switch two transceivers (TRX) to corresponding channels for receiving and sending.

It can be learned that the AP device is used as a central scheduling node of the STA device, and the AP device needs to have two independent radio frequency baseband circuits to operate on two channels in an asynchronous receiving and sending manner. The STA device may use a single radio frequency baseband circuit. However, receiving and sending behaviors of the STA device depend on scheduling of the AP device. The STA device cannot actively detect a channel, and the STA device cannot contend for and preempt a channel. Consequently, the STA device is highly dependent on the AP device, and a configuration of the AP device causes high hardware costs.

To resolve the foregoing related technical problem, this disclosure provides a terminal device, a P2P communication method, and a communication system. When the terminal device executes a delay-sensitive service, two channels are available for selection each time a service packet is transmitted, and one of the two channels is available. In other words, the service packet is transmitted (sent or received) on a same channel each time the service packet is transmitted, to ensure that a service transmission delay is stable at a low level, also guarantee service experience of a device, and maintain a communication specification of the device without increasing radio frequency costs of the device.

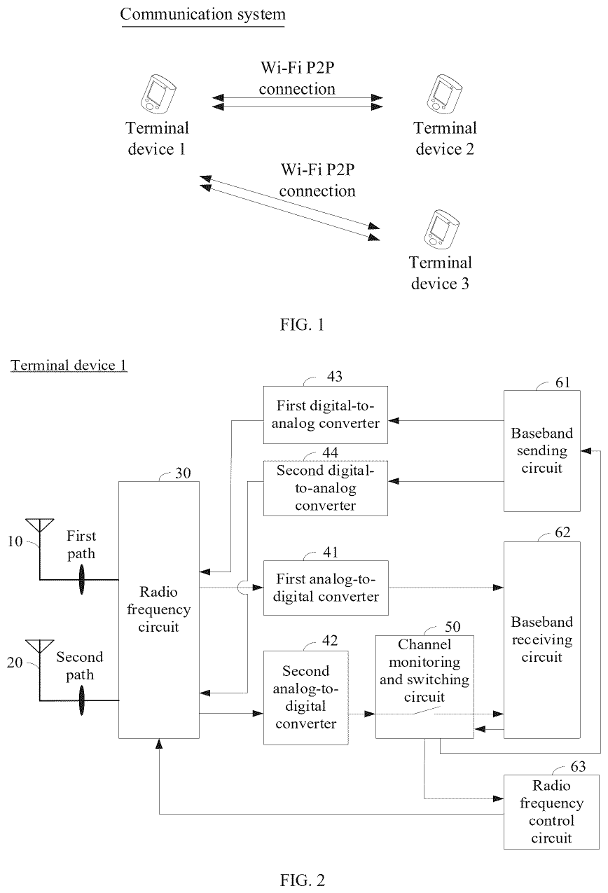

FIG. 1 is a diagram of a structure of a communication system according to an embodiment of this disclosure. As shown in FIG. 1, the communication system in this disclosure is applicable to various application scenarios of a Wi-Fi P2P connection.

The communication system in this disclosure may include a plurality of terminal devices.

The terminal device may be user equipment (UE), an access terminal, a user unit, a subscriber station, a subscriber unit, a subscriber station, a mobile station, a remote station, a remote terminal, a mobile device, a user terminal, a terminal, a wireless communication device, a user agent, a user device or user equipment, or a user apparatus. The terminal device may alternatively be a device such as a personal communication service (PCS) phone, a cellular phone, a cordless phone, a session initiation protocol (SIP) phone, a wireless local loop (WLL) station, a personal digital assistant (PDA), a handheld device with a wireless communication function, a computing device, or another processing device connected to a wireless modulator, a vehicle-mounted device, a wearable device, or a terminal in the Internet of vehicles. Alternatively, the terminal device may be a device supporting Wi-Fi P2P, such as a mobile phone, a television, a tablet computer, a laptop computer, a wearable device, a personal computer (PC), a palmtop computer, a netbook, a personal digital assistant (PDA), a mobile Internet device (MID), a vehicle-mounted device, a VR device, an AR device, a smart television, a smart screen, a high-definition television, a 4K television, a smart speaker, a smart projector, or a smart robot. A specific type of the terminal device is not limited in this disclosure.

A quantity of terminal devices in the communication system is not limited in this disclosure. For ease of description, in FIG. 1, an example in which the communication system may include a terminal device 1, a terminal device 2, and a terminal device 3 is used for illustration.

In some implementations, one of the terminal device 1, the terminal device 2, and the terminal device 3 may be used as a group owner (GO) node, and remaining terminal devices may be used as group client (GC) nodes.

A Wi-Fi P2P connection can be established between the terminal device 1 and the terminal device 2, so that a delay-sensitive service such as projection and multi-screen collaboration can be borne between the terminal device 1 and the terminal device 2. The delay-sensitive service requires a stable low delay in transmission of a service packet.

In addition, capabilities of the terminal device 1 and the terminal device 2 are equivalent. Both the terminal device 1 and the terminal device 2 may execute the delay-sensitive service. In other words, the terminal device 1 and the terminal device 2 are interchanged, and the terminal device 1 can send a packet and receive a packet.

In some implementations, a structure of the terminal device 2 may be the same as that of the terminal device 1. For ease of description, in this disclosure, an example in which the terminal device 2 and the terminal device 1 have the same structure is used for description.

In addition, a Wi-Fi P2P connection can also be established between the terminal device 1 and the terminal device 3. For a specific implementation, refer to descriptions that the Wi-Fi P2P connection can be established between the terminal device 1 and the terminal device 2. Details are not described herein again. Moreover, a Wi-Fi P2P connection can also be established between the terminal device 2 and the terminal device 3 (not shown in FIG. 1).

For ease of description, in this disclosure, an example in which the terminal device 1 transmits a service packet of a delay-sensitive service to another terminal device is used for illustration. The another terminal device may be a terminal device other than the terminal device 1, for example, the terminal device 2 or the terminal device 3.

FIG. 2 is a diagram of a structure of a terminal device according to an embodiment of this disclosure. As shown in FIG. 2, the terminal device 1 in this disclosure may include a first antenna 10, a second antenna 20, a radio frequency (RF) circuit 30, a channel monitoring and switching circuit 50, a baseband receiving circuit 62, and a radio frequency control circuit 63.

The radio frequency circuit 30 is separately connected to the first antenna 10 and the baseband receiving circuit 62, the first antenna 10, the radio frequency circuit 30, and the baseband receiving circuit 62 form a first path, the radio frequency circuit 30 is further separately connected to the second antenna 20 and the channel monitoring and switching circuit 50, the second antenna 20, the radio frequency circuit 30, and the channel monitoring and switching circuit 50 form a second path, the channel monitoring and switching circuit 50 is further connected to the baseband receiving circuit 62, and the radio frequency control circuit 63 is connected to the radio frequency circuit 30 and the channel monitoring and switching circuit 50. A connection topology between the circuits may indicate that a logical connection relationship exists between the corresponding circuits.

It should be understood that the channel monitoring and switching circuit 50 may be a circuit including a plurality of components, or may be an integrated chip, or may be a plurality of chips that are electrically connected. In addition, the channel monitoring and switching circuit 50 may be separately disposed, or may be integrated with a circuit in the terminal device 1, or may be partially separately disposed and partially integrated with a circuit in the terminal device 1. For example, the channel monitoring and switching circuit 50 may be integrated into the baseband circuit mentioned above.

In addition, the terminal device 1 may further include a first analog-to-digital converter (ADC) 41, a second ADC 42, a first digital-to-analog converter (DAC) 43, a second DAC 44, and a baseband sending circuit 61.

The radio frequency circuit 30 is further separately connected to the first ADC 41 and the first DAC 43 on the first path, the radio frequency circuit 30 is further separately connected to the second ADC 42 and the second DAC 44 on the second path, the first ADC 41 is further connected to the baseband receiving circuit 62, the second ADC 42 is further connected to the channel monitoring and switching circuit 50, the channel monitoring and switching circuit 50 is further connected to the baseband sending circuit 61, and the baseband sending circuit 61 is further separately connected to the first DAC 43 and the second DAC 44. A connection topology between the circuits may indicate that a logical connection relationship exists between the corresponding circuits.

It should be understood that the first ADC 41, the second ADC 42, the first DAC 43, the second DAC 44, the baseband sending circuit 61, the baseband receiving circuit 62, and the radio frequency control circuit 63 may be integrated, for example, integrated into the baseband (baseband, BB) circuit, or may be separately disposed. This is not limited in this disclosure.

The first ADC 41, the second ADC 42, the first DAC 43, the second DAC 44, the baseband sending circuit 61, the baseband receiving circuit 62, and the radio frequency control circuit 63 are all Wi-Fi physical layer circuits.

On the first path, functions of the first antenna 10, the radio frequency circuit 30, the first ADC 41, the first DAC 43, the baseband receiving circuit 62, and the baseband sending circuit 61 are described as follows:

The first antenna 10 is configured to send and receive an electromagnetic wave signal, for example, a Wi-Fi frame of a delay-sensitive service or a service packet of the delay-sensitive service. The first antenna 10 may be configured to cover one or more communication bands. The first antenna 10 may include one or more of an antenna in a 2.4G band, an antenna in a 5G band, or an antenna in a 6G band.

The radio frequency circuit 30 is configured to perform processing such as filtering and amplification, down-conversion, analog-to-digital conversion, and digital filtering on a signal from an air interface of the first antenna 10, obtain a baseband signal through the first ADC 41, and send the baseband signal to the baseband receiving circuit 62.

The radio frequency circuit 30 is further configured to perform processing such as digital-to-analog conversion, up-conversion, and filtering and amplification on a baseband signal output by the baseband sending circuit 61 through the first DAC 43, and transmit the signal through the first antenna 10.

The radio frequency circuit 30 may convert a radio frequency signal into a baseband signal, or may convert a radio frequency signal into an intermediate frequency (intermediate frequency, IF) signal, and then convert the intermediate frequency signal into a baseband signal. This is not limited in this disclosure.

Under control of the radio frequency control circuit 63, the radio frequency circuit 30 is configured to configure, based on a frequency of a channel that needs to be configured and is notified by the radio frequency control circuit 63, a channel on which the radio frequency circuit 30 operates on the first path.

Under control of the radio frequency control circuit 63, the radio frequency circuit 30 is further configured to switch, based on a frequency of a channel that needs to be switched and is notified by the radio frequency control circuit 63, a channel on which the radio frequency circuit 30 operates on the first path.

The first ADC 41 is configured to perform analog-to-digital conversion on a signal output by the radio frequency circuit 30, and may convert an analog baseband signal into a digital baseband signal, and transmit the digital baseband signal to the baseband receiving circuit 62.

The first DAC 43 is configured to perform digital-to-analog conversion on a signal transmitted by the baseband sending circuit 61, and may convert a digital baseband signal into an analog baseband signal, and transmit the analog baseband signal to the radio frequency circuit 30.

The baseband receiving circuit 62 is configured to monitor the channel on which the radio frequency circuit 30 operates on the first path, and send monitoring information of the channel on which the radio frequency circuit 30 operates on the first path to the channel monitoring and switching circuit 50.

The monitoring information of the channel on which the radio frequency circuit 30 operates on the first path may indicate a channel state of the channel on which the radio frequency circuit 30 operates on the first path, that is, whether the channel on which the radio frequency circuit 30 operates on the first path is idle or busy.

The monitoring information of the channel on which the radio frequency circuit 30 operates on the first path may further indicate that another terminal device needs to send a service packet on the channel on which the radio frequency circuit 30 operates on the first path, for example, the another terminal device sends a control frame in a Wi-Fi frame on the channel on which the radio frequency circuit 30 operates on the first path.

The baseband receiving circuit 62 is further configured to perform processing such as demodulation and decoding on a baseband signal output by the radio frequency circuit 30 on the first path to obtain information corresponding to a Wi-Fi frame or a service packet.

The radio frequency control circuit 63 is configured to receive a notification sent by the channel monitoring and switching circuit 50, and control, based on a frequency of a channel indicated by the notification, the radio frequency circuit 30 to switch the channel on which the radio frequency circuit 30 operates on the first path.

The radio frequency control circuit 63 is further configured to control, based on the frequency of the configured channel, the radio frequency circuit 30 to configure the channel on which the radio frequency circuit 30 operates on the first path.

The baseband sending circuit 61 is configured to perform processing such as encoding and modulation on a signal corresponding to a Wi-Fi frame or a service packet on the first path, to obtain a baseband signal, and send the baseband signal to the radio frequency circuit 30.

The Wi-Fi frame may include a control frame and another frame. This is not limited in this disclosure. The control frame may be a RTS control frame, a clear to send (CTS) control frame, an acknowledgment (ACK) control frame, or the like.

On the second path, functions of the second antenna 20, the radio frequency circuit 30, the second ADC 42, the second DAC 44, the channel monitoring and switching circuit 50, the baseband receiving circuit 62, and the baseband sending circuit 61 are described as follows:

The second antenna 20 is configured to send and receive an electromagnetic wave signal, for example, a Wi-Fi frame of a delay-sensitive service or a service packet of the delay-sensitive service. The second antenna 20 may be configured to cover one or more communication bands. The second antenna 20 may include one or more of an antenna in a 2.4G band, an antenna in a 5G band, or an antenna in a 6G band.

The radio frequency circuit 30 is configured to perform processing such as filtering and amplification, down-conversion, analog-to-digital conversion, and digital filtering on a signal from an air interface of the second antenna 20, obtain a baseband signal through the second ADC 42, and send the baseband signal to the baseband receiving circuit 62 or the channel monitoring and switching circuit 50.

The radio frequency circuit 30 is further configured to perform processing such as digital-to-analog conversion, up-conversion, and filtering and amplification on a baseband signal output by the baseband sending circuit 61 through the second DAC 44, and transmit the signal through the first antenna 10.

The radio frequency circuit 30 may convert a radio frequency signal into a baseband signal, or may convert a radio frequency signal into an intermediate frequency (intermediate frequency, IF) signal, and then convert the intermediate frequency signal into a baseband signal. This is not limited in this disclosure.

In addition, on the first path and the second path, circuits included in the radio frequency circuit 30 may partially overlap or be totally different.

Under control of the radio frequency control circuit 63, the radio frequency circuit 30 is configured to configure, based on a frequency of a channel that needs to be configured and is notified by the radio frequency control circuit 63, a channel on which the radio frequency circuit 30 operates on the second path.

Under control of the radio frequency control circuit 63, the radio frequency circuit 30 is further configured to switch, based on a frequency of a channel that needs to be switched and is notified by the radio frequency control circuit 63, a channel on which the radio frequency circuit 30 operates on the second path.

The second ADC 42 is configured to perform analog-to-digital conversion on a signal output by the radio frequency circuit 30, may convert an analog baseband signal into a digital baseband signal, and transmit the digital baseband signal to the baseband receiving circuit 62 or the channel monitoring and switching circuit 50 for sending the baseband signal.

The second DAC 44 is configured to perform digital-to-analog conversion on a signal transmitted by the baseband sending circuit 61, and may convert a digital baseband signal into an analog baseband signal, and transmit the analog baseband signal to the radio frequency circuit 30.

The channel monitoring and switching circuit 50 is configured to monitor the channel on which the radio frequency circuit 30 operates on the second path.

Monitoring information of the channel on which the radio frequency circuit 30 operates on the second path may indicate a channel state of the channel on which the radio frequency circuit 30 operates on the second path, that is, whether the channel on which the radio frequency circuit 30 operates on the second path is idle or busy.

The monitoring information of the channel on which the radio frequency circuit 30 operates on the second path may further indicate that another terminal device needs to send a service packet on the channel on which the radio frequency circuit 30 operates on the second path, for example, the another terminal device sends a control frame in a Wi-Fi frame on the channel on which the radio frequency circuit 30 operates on the second path.

The channel monitoring and switching circuit 50 is further configured to receive the monitoring information that is sent by the baseband receiving circuit 62 and that is of the channel on which the radio frequency circuit 30 operates on the first path, and select, based on the monitoring information of the channel on which the radio frequency circuit 30 operates on the first path and the monitoring information of the channel on which the radio frequency circuit 30 operates on the second path, a channel on which the radio frequency circuit 30 simultaneously operates on the first path and the second path from channels on which the radio frequency circuit 30 operates on the first path and the second path.

The channel monitoring and switching circuit 50 may be used as a switch of whether the baseband receiving circuit 62 accesses the second channel.

The channel monitoring and switching circuit 50 is further configured to break a connection between the radio frequency circuit 30 and the baseband receiving circuit 62 on the second path when a service packet does not need to be transmitted or before a service packet needs to be transmitted, that is, break a connection between the second ADC 42 and the baseband receiving circuit 62, and notify the radio frequency control circuit 63 of the respective channels on which the radio frequency circuit 30 operates on the first path and the second path.

The channel monitoring and switching circuit 50 is further configured to establish the connection between the radio frequency circuit 30 and the baseband receiving circuit 62 on the second path when the service packet needs to be transmitted, that is, establish a connection between the second ADC 42 and the baseband receiving circuit 62, and notify the radio frequency control circuit 63 of the channel on which the radio frequency circuit 30 simultaneously operates on the first path and the second path.

The baseband receiving circuit 62 is further configured to perform processing such as demodulation and decoding on a baseband signal output by the radio frequency circuit 30 on the second path, to obtain information corresponding to a Wi-Fi frame or a service packet.

The radio frequency control circuit 63 is configured to receive a notification sent by the channel monitoring and switching circuit 50, and control, based on a frequency of a channel indicated by the notification, the radio frequency circuit 30 to switch the channel on which the radio frequency circuit 30 operates on the second path.

The radio frequency control circuit 63 is further configured to control, based on the frequency of the configured channel, the radio frequency circuit 30 to configure the channel on which the radio frequency circuit 30 operates on the second path.

The baseband sending circuit 61 is configured to perform processing such as encoding and modulation on a signal corresponding to a Wi-Fi frame or a service packet on the second path, to obtain a baseband signal, and send the baseband signal to the radio frequency circuit 30.

For a specific implementation of the Wi-Fi frame, refer to the foregoing descriptions. Details are not described herein again.

Moreover, in addition to the foregoing circuits, the terminal device 1 may further include a power supply circuit, a control circuit (for example, a central processing unit (CPU)), a service processing circuit, and a peripheral device.

The control circuit is connected to the baseband circuit and the service processing circuit mentioned above. The control circuit is configured to control the baseband circuit and the service processing circuit to perform corresponding processing. The service processing circuit is configured to transmit the information corresponding to the service packet to the peripheral device, and transmit a signal about the service packet from the peripheral device to the baseband circuit. The power supply circuit provides an operating power supply for the first antenna 10, the second antenna 20, the radio frequency circuit 30, the baseband circuit, the channel monitoring and switching circuit 50, the control circuit, the service processing circuit, and the peripheral device.

It should be understood that in addition to the foregoing division manner, the circuits in the terminal device 1 may further have another division manner.

Based on the foregoing descriptions, the first antenna 10 may transmit a signal on one path, that is, the first path, and the second antenna 20 may transmit a signal on another path, that is, the second path. It can be learned that the terminal device 1 includes two paths.

Correspondingly, two Wi-Fi P2P connections may be established between the terminal device 1 and another terminal device on the first path and the second path.

A Wi-Fi P2P connection may be established between the terminal device 1 and the another terminal device on a channel corresponding to the first path. Another Wi-Fi P2P connection may be established between the terminal device 1 and the another terminal device on a channel corresponding to the second path.

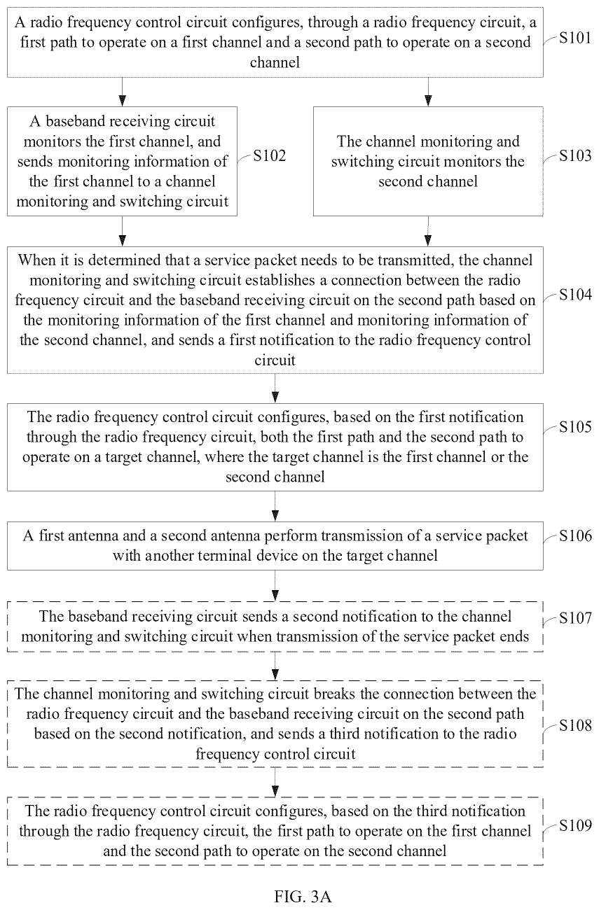

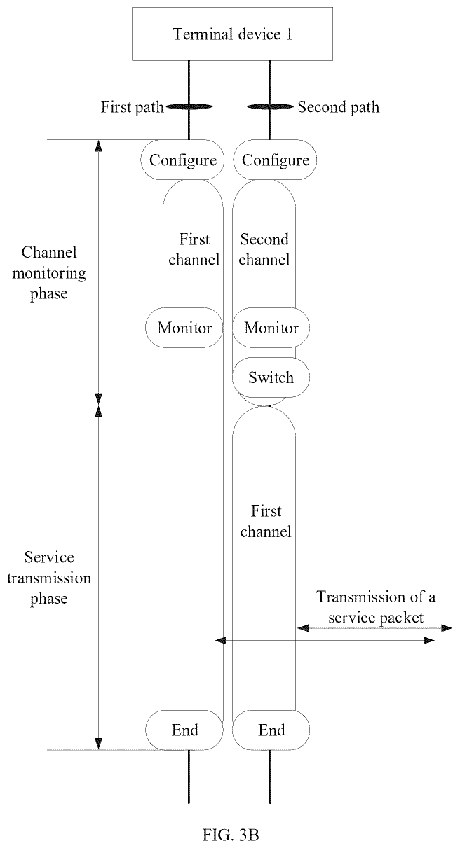

The following uses an example in which a process in which the terminal device 1 executes a delay-sensitive service is divided into a channel monitoring phase and a service transmission phase. Based on the structure of the terminal device 1 shown in FIG. 2, with reference to FIG. 3A and FIG. 3B, specific implementation processes in which circuits of the terminal device 1 implement a P2P communication method provided in this disclosure in the channel monitoring phase and the service transmission phase are described in detail.

The channel monitoring phase may be understood as a phase of monitoring a channel. The service transmission phase may be understood as a phase of another process (for example, sending a Wi-Fi frame, receiving a Wi-Fi frame, sending a service packet, or receiving a service packet) other than channel monitoring.

FIG. 3A is a schematic flowchart of a P2P communication method according to an embodiment of this disclosure. FIG. 3B is a diagram of a service packet transmission scenario of a terminal device according to an embodiment of this disclosure.

To simplify illustration, in FIG. 3B, in a channel monitoring phase, a first path uses a Wi-Fi P2P connection on a first channel, and a second path uses a Wi-Fi P2P connection on a second channel. In a service transmission phase from the channel monitoring phase, an example in which a target channel is the first channel is used, the second path uses a Wi-Fi P2P connection on the first channel, and the second path uses another Wi-Fi P2P connection on the first channel.

As shown in FIG. 3A and FIG. 3B, the P2P communication method in this disclosure may include S101 to S106, or S101 to S109.

S101 to S103 are the channel monitoring phase, and S104 to S106 are the service transmission phase from the channel monitoring phase. S107 to S109 are optional steps.

S101: A radio frequency control circuit configures, through a radio frequency circuit, a first path to operate on a first channel and a second path to operate on a second channel.

In the channel monitoring phase, a connection between a first ADC 41 and a baseband receiving circuit 62 is established.

Based on this, the radio frequency control circuit 63 may configure, through the radio frequency circuit 30, the radio frequency circuit 30 on the first path to operate on the first channel.

In a feasible implementation, in the channel monitoring phase, the radio frequency control circuit 63 may control, by default, the radio frequency circuit 30 to configure the radio frequency circuit 30 on the first path to operate on the first channel.

In a feasible implementation, when receiving a notification, the radio frequency control circuit 63 may control the radio frequency circuit 30 to configure the radio frequency circuit 30 on the first path to operate on the first channel.

The notification may indicate the channel monitoring phase, for example, indicate at least one of the following: a connection between a second ADC 42 and the baseband receiving circuit 62 is broken, a channel on which the radio frequency circuit 30 operates on the first path is switched, or a channel on which the radio frequency circuit 30 operates on the first path is the first channel. In addition, the notification may be sent by a channel monitoring and switching circuit 50 or another circuit in a terminal device 1.

It can be learned that a path on which a first antenna 10, the radio frequency circuit 30, the first ADC 41, and the baseband receiving circuit 62 are located is the first path, a path on which a baseband sending circuit 61, a first DAC 43, the radio frequency circuit 30, and the first antenna 10 are located is the first path, and the first path operates on the first channel. In this way, data transmission is performed between the terminal device 1 and another terminal device through one Wi-Fi P2P connection on the first channel.

In the channel monitoring phase, the connection between the second ADC 42 and the baseband receiving circuit 62 is broken, and a connection between the second ADC 42 and the channel monitoring and switching circuit 50 is established.

Based on this, the radio frequency control circuit 63 may configure, through the radio frequency circuit 30, the radio frequency circuit 30 on the second path to operate on the second channel.

In a feasible implementation, in the channel monitoring phase, the radio frequency control circuit 63 may control, by default, the radio frequency circuit 30 to configure the radio frequency circuit 30 on the second path to operate on the second channel.

In a feasible implementation, when receiving a notification, the radio frequency control circuit 63 may control the radio frequency circuit 30 to configure the radio frequency circuit 30 on the second path to operate on the second channel.

The notification may indicate the channel monitoring phase, for example, indicate at least one of the following: the connection between the second ADC 42 and the baseband receiving circuit 62 is broken, a channel on which the radio frequency circuit 30 operates on the second path is switched, or a channel on which the radio frequency circuit 30 operates on the second path is the second channel. In addition, the notification may be sent by the channel monitoring and switching circuit 50 or another circuit in the terminal device 1.

A specific implementation of the first channel and the second channel is not limited in this disclosure.

In some implementations, the first channel and the second channel may be two channels in a same band, for example, any one of a channel in a 2.4G band and a channel in the 2.4G band, a channel in a 5G band and a channel in the 5G band, or a channel in a 6G band and a channel in the 6G band. Alternatively, the first channel and the second channel may be two channels in different bands, for example, any one of a channel in a 2.4G band and a channel in a 5G band, a channel in a 2.4G band and a channel in a 6G band, or a channel in a 5G band and a channel in a 6G band.

It can be learned that a path on which a second antenna 20, the radio frequency circuit 30, the second ADC 42, and the channel monitoring and switching circuit 50 are located is the second path, the baseband sending circuit 61, a second DAC 44, the radio frequency circuit 30, and the second antenna 20 are the second path, and the second path operates on the second channel. In this way, data transmission is performed between the terminal device 1 and the another terminal device through one Wi-Fi P2P connection on the second channel.

S102: The baseband receiving circuit monitors the first channel, and sends monitoring information of the first channel to the channel monitoring and switching circuit.

The baseband receiving circuit 62 may monitor the first channel based on a signal on the first channel, to obtain the monitoring information of the first channel.

The signal on the first channel may be understood as a baseband signal that is output to the baseband receiving circuit 62 and that is obtained after a signal from an air interface of the first antenna 10 is processed by the radio frequency circuit 30 and the first ADC 41 on the first path. Correspondingly, the signal from the air interface of the first antenna 10 is a signal corresponding to a Wi-Fi frame sent by the another terminal device.

The monitoring mentioned in this disclosure includes physical carrier monitoring and virtual carrier monitoring. The virtual carrier monitoring is a type of carrier monitoring, and is relative to the physical carrier monitoring. The virtual carrier monitoring is to learn of a channel state through control information instead of actually detecting a physical channel.

The monitoring information of the first channel may indicate a channel state of the first channel, that is, whether the first channel is idle or busy.

In some implementations, the monitoring information of the first channel may include but is not limited to signal energy of the first channel, a signal feature (such as a spread spectrum signal and a carrier frequency) of the first channel, a signal strength of the first channel, a signal amplitude of the first channel, and the like.

For example, when signal energy of a channel is lower than a threshold, the channel is idle. Alternatively, when a signal feature of a channel, such as a spread spectrum signal and a carrier frequency is lower than a threshold, the channel is idle. Alternatively, with reference to the foregoing two manners, whether a channel is idle or busy may be determined.

In addition, the monitoring information of the first channel may further indicate that the another terminal device needs to send a service packet on the first channel. For example, the monitoring information of the first channel may be a Wi-Fi frame sent by the another terminal device on the first channel.

Further, the baseband receiving circuit 62 may send the monitoring information of the first channel to the channel monitoring and switching circuit 50 based on a connection between the baseband receiving circuit 62 and the channel monitoring and switching circuit 50.

S103: The channel monitoring and switching circuit monitors the second channel.

The channel monitoring and switching circuit 50 may monitor the second channel based on a signal on the second channel, to obtain monitoring information of the second channel.

The signal on the second channel may be understood as a baseband signal that is output to the channel monitoring and switching circuit 50 and that is obtained after a signal from an air interface of the second antenna 20 is processed by the radio frequency circuit 30 and the second ADC 42 on the second path.

The monitoring information of the second channel may indicate a channel state of the second channel, that is, whether the second channel is idle or busy. The monitoring information of the second channel may further indicate that the another terminal device needs to send a service packet on the second channel.

For a specific implementation of the monitoring information of the second channel, refer to the descriptions of the monitoring information of the first channel in S101. Details are not described herein again.

In conclusion, in the channel monitoring phase, the first path and the second path may operate on two channels respectively. Wi-Fi P2P connections between the terminal device 1 and the another terminal device on the two channels are two Wi-Fi P2P connections. Therefore, the terminal device 1 may simultaneously operate on the two channels, so that the terminal device 1 can have a multi-radio frequency multi-link capability.

Based on the descriptions of S101 to S103, in the channel monitoring phase, the terminal device 1 may configure, by using a setting of the channel monitoring and switching circuit 50 and a related connection relationship, the radio frequency circuit 30 to operate on the two channels, so that the terminal device 1 can have a single radio frequency multi-link capability without increasing radio frequency costs caused by adding a baseband side circuit, and it is ensured that a radio frequency capability of the terminal device 1 in the service transmission phase is not rolled back.

In addition, the terminal device 1 may separately monitor the two channels through the baseband receiving circuit 62 and the channel monitoring and switching circuit 50, so that the two paths in the terminal device 1 can perform channel contention on the two channels, to prepare for channel access and channel use.

It should be understood that S102 and S103 are not subject to a time sequence, and S102 and S103 may be simultaneously performed, or may be sequentially performed.

S104: When it is determined that a service packet needs to be transmitted, the channel monitoring and switching circuit establishes a connection between the radio frequency circuit and the baseband receiving circuit on the second path based on the monitoring information of the first channel and the monitoring information of the second channel, and sends a first notification to the radio frequency control circuit.

In a packet sending scenario of the terminal device 1, a service packet that needs to be sent is stored in a cache queue of the terminal device 1. The channel monitoring and switching circuit 50 may determine whether the service packet is stored in the cache queue of the terminal device 1.

If no service packet is stored in the cache queue of the terminal device 1, the channel monitoring and switching circuit 50 may determine that the service packet does not need to be sent. Further, the terminal device 1 continues to monitor the first channel and the second channel.

If the service packet is stored in the cache queue of the terminal device 1, the channel monitoring and switching circuit 50 may determine that the service packet needs to be sent. Further, the channel monitoring and switching circuit 50 may select, from the first channel and the second channel based on the monitoring information of the first channel and the monitoring information of the second channel, a target channel used to send the service packet, and determine to enter the service transmission phase from the channel monitoring phase.

In a packet receiving scenario of the terminal device 1, the terminal device 1 may determine, based on the monitoring information of the first channel and the monitoring information of the second channel, whether the another terminal device needs to send a service packet to the terminal device 1.

If the another terminal device does not need to send the service packet to the terminal device 1, the channel monitoring and switching circuit 50 may determine that the service packet does not need to be received. Further, the terminal device 1 continues to monitor the first channel and the second channel.

If the another terminal device needs to send the service packet to the terminal device 1, the channel monitoring and switching circuit 50 may determine that the service packet needs to be received. Further, the channel monitoring and switching circuit 50 may select, from the first channel and the second channel based on the monitoring information of the first channel and the monitoring information of the second channel, a target channel used to receive the service packet, and determine to enter the service transmission phase from the channel monitoring phase.

Therefore, in the service transmission phase, the channel monitoring and switching circuit 50 may establish the connection between the second ADC 42 and the baseband receiving circuit 62, and send the first notification to the radio frequency control circuit 63.

In addition, the channel monitoring and switching circuit 50 may further send a fourth notification to the baseband sending circuit 61.

The first notification or the fourth notification may indicate that the terminal device 1 needs to perform transmission of the service packet on the target channel, for example, indicate at least one of the following: the connection between the second ADC 42 and the baseband receiving circuit 62 is established, a channel on which the radio frequency circuit 30 operates on the first path or the second path is switched, or a channel on which the radio frequency circuit 30 simultaneously operates on the first path and the second path is the target channel. In addition, a specific implementation of the first notification and the fourth notification is not limited in this disclosure.

S105: The radio frequency control circuit configures, based on the first notification through the radio frequency circuit, both the first path and the second path to operate on the target channel, where the target channel is the first channel or the second channel.

The radio frequency control circuit 63 may configure, based on the target channel indicated by the first notification through the radio frequency circuit 30, the radio frequency circuit 30 on the first path and the second path to operate on the target channel.

In other words, the first path on which the first antenna 10, the radio frequency circuit 30, the first ADC 41, and the baseband receiving circuit 62 are located operates on the target channel. Correspondingly, the first path on which the baseband sending circuit 61, the first DAC 43, the radio frequency circuit 30, and the first antenna 10 are located operates on the target channel.

In addition, the second path on which the second antenna 20, the radio frequency circuit 30, the second ADC 42, and the baseband receiving circuit 62 are located operates on the target channel. Correspondingly, the second path on which the baseband sending circuit 61, the second DAC 44, the radio frequency circuit 30, and the second antenna 20 are located operates on the target channel.

When the target channel is the first channel, the radio frequency control circuit 63 may configure, through the radio frequency circuit 30, the radio frequency circuit 30 on the first path to continue to operate on the first channel, and the radio frequency circuit 30 on the second path to switch to operate on the first channel.

Alternatively, when the target channel is the second channel, the radio frequency control circuit 63 may configure, through the radio frequency circuit 30, the radio frequency circuit 30 on the first path to switch to operate on the second channel, and the radio frequency circuit 30 on the second path to continue to operate on the second channel.

Because a spatial path for access and service transmission in a band may be referred to as a link (link), access and service transmission in a plurality of bands are referred to as multi-link (ML). Therefore, a Wi-Fi P2P connection between the terminal device 1 and the another terminal device may be considered as a link. In this case, for the first path and the second path, two Wi-Fi P2P connections between the terminal device 1 and the another terminal device may be considered as two links. It can be learned that the terminal device 1 has a multi-radio frequency or single radio frequency multi-link capability.

It is assumed that on the first path, a Wi-Fi P2P connection between the terminal device 1 and the another terminal device is link1. On the second path, a Wi-Fi P2P connection between the terminal device 1 and the another terminal device is link2.

In the channel monitoring phase, on the first path, a channel on link1 is the first channel, and on the second path, a channel on link2 is the second channel. It can be learned that the terminal device 1 has the multi-radio frequency multi-link capability. In the service transmission phase, on the first path, a channel on link1 is the first channel, and on the second path, a channel on link2 is the first channel. The foregoing content is illustrated by using FIG. 3B. It can be learned that the terminal device 1 has the single radio frequency multi-link capability.

Alternatively, in the channel monitoring phase, on the first path, a channel on link1 is the first channel, and on the second path, a channel on link2 is the second channel. It can be learned that the terminal device 1 has the multi-radio frequency multi-link capability. In the service transmission phase, on the first path, a channel on link1 is the second channel, and on the second path, a channel on link2 is the second channel. The foregoing content is not illustrated. It can be learned that the terminal device 1 has the single radio frequency multi-link capability.

In conclusion, in the service transmission phase, the first path and the second path simultaneously operate on the same channel. Wi-Fi P2P connections between the terminal device 1 and the another terminal device on the same channel are a same Wi-Fi P2P connection. Therefore, the terminal device 1 may implement sending and receiving of a 2×2 MIMO capability, so that a radio frequency capability of the terminal device 1 remains undiminished.

S106: The first antenna and the second antenna perform transmission of the service packet with the another terminal device on the target channel.

In the service transmission phase, the radio frequency circuit 30 on both the first path and the second path operates on the same channel (that is, the target channel). Therefore, the terminal device 1 may send the service packet to the another terminal device on the target channel through the first antenna 10 and the second antenna 20. Alternatively, the terminal device 1 may receive the service packet from the another terminal device on the target channel through the first antenna 10 and the second antenna 20.

Based on the descriptions of S105 and S106, a channel contention mechanism may be improved when the terminal device 1 keeps no rollback of the radio frequency capability of the terminal device 1, so that the two paths in the terminal device 1 can simultaneously perform parallel channel access and channel use, to avoid a problem of an increased delay caused by channel congestion, and the service packet is transmitted on the same channel, to provide a stable low delay for a delay-sensitive service.

S107: The baseband receiving circuit sends a second notification to the channel monitoring and switching circuit when transmission of the service packet ends.

S108: The channel monitoring and switching circuit breaks the connection between the radio frequency circuit and the baseband receiving circuit on the second path based on the second notification, and sends a third notification to the radio frequency control circuit.

S109: The radio frequency control circuit configures, based on the third notification through the radio frequency circuit, the first path to operate on the first channel and the second path to operate on the second channel.

S107 to S109 are optional steps.

After transmission of the service packet ends, the terminal device 1 may break the connection between the second ADC 42 and the baseband receiving circuit 62, configure the radio frequency circuit on the first path to operate on the first channel, and configure the radio frequency circuit 30 on the second path to operate on the second channel.

In some implementations, the terminal device 1 may be restored to the channel monitoring phase by default after transmission of the service packet ends. In other words, the channel monitoring and switching circuit 50 may break the connection between the second ADC 42 and the baseband receiving circuit 62 by default. The radio frequency control circuit 63 may control, by default, the radio frequency circuit 30, to: configure the radio frequency circuit 30 on the first path to operate on the first channel, and configure, by default, the radio frequency circuit 30 on the second path to operate on the second channel.

In some implementations, in the packet sending scenario of the terminal device 1, after receiving of the service packet ends, the another terminal device may send an acknowledgment control frame to the terminal device 1 on the target channel. The acknowledgment control frame indicates that receiving of the service packet by the another terminal device ends. Correspondingly, the terminal device 1 may receive the acknowledgment control frame on the target channel through the first antenna 10 and the second antenna 20. When receiving the acknowledgment control frame, the terminal device 1 may determine that sending of the service packet ends.

In the packet receiving scenario of the terminal device 1, after receiving of the service packet ends, the terminal device 1 may send an acknowledgment control frame to the another terminal device on the target channel. The acknowledgment control frame indicates that receiving of the service packet by the terminal device 1 ends. Correspondingly, the terminal device 1 may send the acknowledgment control frame on the target channel through the first antenna 10 and the second antenna 20. When receiving the acknowledgment control frame, the another terminal device may determine that sending of the service packet ends, and no longer continues to send the service packet.

In conclusion, after receiving the acknowledgment control frame sent by the another terminal device or obtaining the acknowledgment control frame generated by the terminal device 1, the baseband receiving circuit 62 may determine that the service transmission phase ends, and may be restored to the channel monitoring phase. Therefore, the baseband receiving circuit 62 may send the second notification to the channel monitoring and switching circuit 50.

The second notification indicates that transmission of the service packet ends, the service transmission phase ends, or the channel monitoring phase is entered. A specific implementation of the second notification is not limited in this disclosure.

The channel monitoring and switching circuit 50 may break the connection between the second ADC 42 and the baseband receiving circuit 62 based on the second notification, and send a third notification to the radio frequency control circuit 63.

The third notification may indicate that the service transmission phase ends or the channel monitoring phase is entered, for example, indicate at least one of the following: the connection between the second ADC 42 and the baseband receiving circuit 62 is broken, a channel on which the radio frequency circuit 30 operates on the first path or the second path is switched, or a channel on which the radio frequency circuit 30 operates on the first path is the first channel or a channel on which the radio frequency circuit 30 operates on the second path is the second channel. In addition, a specific implementation of the third notification is not limited in this disclosure.

Further, the radio frequency control circuit 63 may control, based on the third notification, the radio frequency circuit 30 to: configure, based on a frequency of the first channel, the radio frequency circuit 30 on the first path to restore to operating on the first channel, and configure, based on a frequency of the second channel, the radio frequency circuit 30 on the second path to restore to operating on the second channel.

It can be learned that, after the service transmission phase ends, the terminal device 1 may be restored to the channel monitoring phase, so that the terminal device 1 can continue to execute a subsequent delay-sensitive service or another service.

Based on the foregoing descriptions, in the channel monitoring phase, the first path may operate on one channel, and the second path may operate on another channel. In the service transmission phase, the first path and the second path may operate on one of the foregoing two channels, that is, the first path and the second path may simultaneously operate on the same channel.

Therefore, when the baseband side circuit is not added to the terminal device 1, the two paths can simultaneously operate on the two channels, and two Wi-Fi P2P connections to the another terminal device on the two channels may be used, without increasing radio frequency costs of the device. In addition, when the radio frequency capability remains undiminished, the two paths can simultaneously operate on the same channel, two identical Wi-Fi P2P connections to the another terminal device on the same channel may be used to bear the delay-sensitive service, and it can be ensured that a delay is stable at a low level, to improve stability of a channel access delay and avoid a channel delay tailing phenomenon.

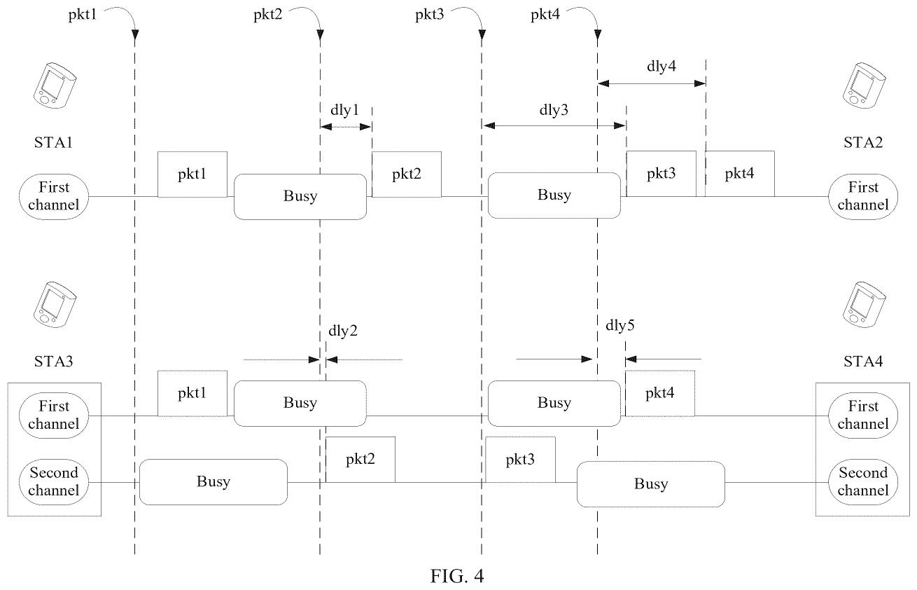

With reference to FIG. 4, the following describes a specific implementation process of a packet sending scenario in which a terminal device 1 executes a delay-sensitive service in a related technology 1 and this disclosure.

FIG. 4 is a diagram of executing a delay-sensitive service by a terminal device 1 in a related technology 1 and this disclosure.

As shown in FIG. 4, in the related technology 1, the terminal device 1 uses a Wi-Fi P2P connection to another terminal device on a channel, and may send a service packet to the another terminal device when the channel is idle.

In this disclosure, in a channel monitoring phase, two paths in the terminal device 1 may use two Wi-Fi P2P connections to the another terminal device on two channels. In a service transmission phase, the two paths of the terminal device 1 may use two identical Wi-Fi P2P connections to the another terminal device on a same channel, and may send a service packet to the another terminal device when either of the two channels is idle.

For ease of description, in FIG. 4, an example in which in the related technology 1, the terminal device 1 is STA1, the another terminal device is STA2, and a Wi-Fi P2P connection between STA1 and STA2 is link1; in this disclosure, the terminal device 1 is STA3, the another terminal device is STA4, two Wi-Fi P2P connections between STA3 and STA4 are link1 and link2 respectively, and service packets of a delay-sensitive service include pkt1, pkt2, pkt3, and pkt4 is used for illustration.

For pkt1, a first channel on link1 is idle, and both STA1 and STA3 may send pkt1 on link1.

For pkt 2, the first channel on link1 is busy (busy), and STA1 can send pkt1 on link1 only when waiting until the first channel on link1 is idle. The first channel on link1 is busy, and a second channel on link2 is idle. STA3 may switch from the first channel on link1 to the second channel, and send pkt1 on link1 and link2.

Clearly, delay duration (dly1) for STA1 to wait until the first channel on link1 is idle is longer than delay duration (dly2) caused by STA3 switching from the first channel on link1 to the second channel.

For pkt 3, the first channel on link1 is busy, and STA1 can send pkt 3 on link1 only when waiting until the first channel on link1 is idle. The second channel on link2 is idle, and STA3 may send pkt 3 on link1 and link2.

Clearly, STA1 has delay duration (dly3) for waiting until the first channel on link1 is idle, and STA3 has no delay or has small delay duration.

For pkt 4, the first channel on link1 is idle, and after sending pkt 3, STA1 may send pkt 4 on link1. The second channel on link2 is busy, and the first channel on link1 is idle. STA3 may switch from the second channel on link2 to the first channel, and send pkt 4 on link1 and link2.

Clearly, delay duration (dly4) for STA1 to wait to send pkt3 is longer than delay duration (dly5) caused by STA3 switching from the second channel on link1 to the first channel.

It can be learned that, in the related technology 1, a delay is not stable enough, a delay jitter is large, a frame freezing phenomenon easily occurs, and delay duration is long. In this disclosure, a delay is stable, a delay jitter is small, and delay duration is short.

In addition, in different levels of interference network load, compared with a manner in which a single Wi-Fi P2P connection is used in the related technology 1, a manner in which single radio frequency multi-Wi-Fi P2P connections are used in this disclosure has a clear delay improvement, as shown in Table 1.

TABLE 1

| Interference network load | 80% | 90% |
|---|---|---|
| Delay duration in a | 73 ms | 84 ms |
| related technology 1 (single Wi-Fi P2P | | |
| connection) | | |
| Delay duration in this | 32 ms | 39 ms |
| disclosure (single radio frequency multi- | | |
| Wi-Fi P2P connections) | | |

In addition, compared with the related technologies 1, 2, and 3, in this disclosure, respective channels on which the two paths in the terminal device 1 operate can be flexibly combined, when radio frequency costs are not increased, the two paths in the channel monitoring phase can operate on two independent channels, so that the two Wi-Fi P2P connections to the another terminal device can be supported. When a radio frequency capability remains undiminished, the two paths in the service transmission phase can operate on the same channel, so that the two identical Wi-Fi P2P connections to the another terminal device can be supported, and sending and receiving of a 2×2 MIMO capability can be implemented.

According to the terminal device and the P2P communication method provided in this disclosure, the radio frequency control circuit may configure the radio frequency circuit on the first path to operate on the first channel, and configure the radio frequency circuit on the second path to operate on the second channel, so that the terminal device can simultaneously use respective Wi-Fi P2P connections on the two channels. The baseband receiving circuit may monitor the first channel, and the channel monitoring and switching circuit may monitor the second channel, so that the two paths in the terminal device can simultaneously perform channel contention, channel access, and channel use on the two channels.

The baseband receiving circuit may send the monitoring information of the first channel to the channel monitoring and switching circuit. When it is determined that the service packet needs to be transmitted, the channel monitoring and switching circuit may establish the connection between the radio frequency circuit and the baseband receiving circuit on the second path based on the monitoring information of the first channel and the monitoring information of the second channel, and send the first notification to the radio frequency control circuit. The radio frequency control circuit may configure, based on the first notification, the radio frequency circuit on the first path and the second path to operate on the target channel, where the target channel is the first channel or the second channel, so that the terminal device can use two identical Wi-Fi P2P connections on a same channel. The first antenna and the second antenna may perform transmission of the service packet with the another terminal device on the target channel.

Therefore, when the baseband side circuit is not added to the terminal device, the two paths can simultaneously operate on the two different channels, so that the terminal device can have the multi-radio frequency multi-link capability. In addition, when the radio frequency capability of the terminal device remains undiminished, the two paths can simultaneously operate on the same channel, so that the terminal device can have the single radio frequency multi-link capability, to provide the stable low-delay transmission capability for the delay-sensitive service. In this way, radio frequency costs of the terminal device are reduced.

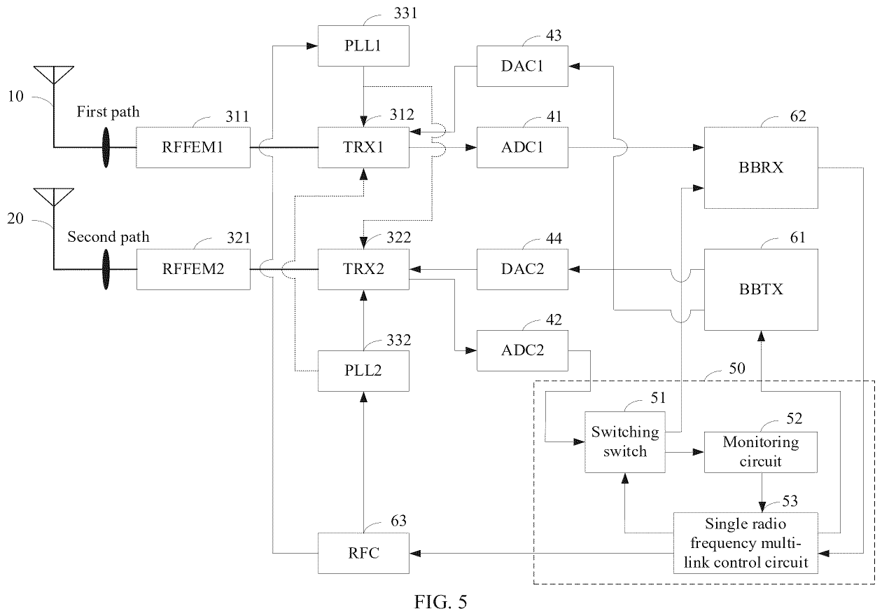

Based on the description of the foregoing embodiment, the circuits in the terminal device 1 are described in detail with reference to FIG. 5 to FIG. 7.

FIG. 5 is a diagram of a structure of a terminal device according to an embodiment of this disclosure. As shown in FIG. 5, a channel monitoring and switching circuit 50 in this disclosure may include a switching switch 51, a monitoring circuit 52, and a single radio frequency multi-link control circuit 53.

A first end of the switching switch 51 is connected to a second ADC 42, a first contact point of the switching switch 51 is connected to a baseband receiving circuit 62, a second contact point of the switching switch 51 is connected to a first end of the monitoring circuit 52, a control end of the switching switch 51 is connected to a first end of the single radio frequency multi-link control circuit 53, a second end of the monitoring circuit 52 is connected to a second end of the single radio frequency multi-link control circuit 53, a third end of the single radio frequency multi-link control circuit 53 is connected to a radio frequency control circuit 63, a fourth end of the single radio frequency multi-link control circuit 53 is connected to the baseband receiving circuit 62, and a fifth end of the single radio frequency multi-link control circuit 53 is connected to a baseband sending circuit 61. A connection topology between the circuits may indicate that a logical connection relationship exists between the corresponding circuits.

In addition, the switching switch 51, the monitoring circuit 52, and the single radio frequency multi-link control circuit 53 may be disposed separately, or may be integrated. This is not limited in this disclosure.

The switching switch 51 is configured to control a routing direction of a signal on a second channel. In other words, in a channel monitoring phase, the switching switch 51 may establish a connection between the second ADC 42 and the baseband receiving circuit 62, and break a connection between the second ADC 42 and the monitoring circuit 52. In a service transmission phase, the switching switch 51 may break the connection between the second ADC 42 and the baseband receiving circuit 62, and establish the connection between the second ADC 42 and the monitoring circuit 52.

The monitoring circuit 52 is configured to monitor/listen to the second channel based on the signal on the second channel in the channel monitoring phase, for example, determine whether the second channel is idle or busy, and receive a control frame in a Wi-Fi frame on the second channel.

It can be learned that the monitoring circuit 52 may include a monitoring function of the second channel and a receiving function of the control frame in the Wi-Fi frame. The baseband receiving circuit 62 may include a monitoring function of the first channel and a receiving function of the Wi-Fi frame.

The single radio frequency multi-link control circuit 53 is configured to receive monitoring information of a first channel and monitoring information of the second channel in the channel monitoring phase.

The single radio frequency multi-link control circuit 53 is further configured to: when entering the service transmission phase from the channel monitoring phase, notify the radio frequency control circuit 63 to configure, through the radio frequency circuit 30, a channel on which the radio frequency circuit 30 operates on the first path and/or a channel on which the radio frequency circuit 30 operates on the second path, notify the switching switch 51 to switch the routing direction of the signal on the second channel, and notify the baseband sending circuit 61 to send a Wi-Fi frame and a service packet, to implement sending triggering, or notify the baseband receiving circuit 62 to receive a Wi-Fi frame and a service packet, to implement receiving triggering.

In addition, the single radio frequency multi-link control circuit 53 is further configured to receive a second notification from the baseband receiving circuit 62 after transmission of the service packet ends, and notify, based on the second notification, the radio frequency control circuit 63 to configure, through the radio frequency circuit 30, a channel on which the radio frequency circuit 30 operates on the first path and/or a channel on which the radio frequency circuit 30 operates on the second path, and notify the switching switch 51 to switch the routing direction of the signal on the second channel.

Based on the foregoing descriptions, the terminal device 1 may use the switching switch 51, the monitoring circuit 52, and the single radio frequency multi-link control circuit 53, so that the two paths in the terminal device 1 can simultaneously perform channel contention, channel access, and channel use on the two channels.

Still with reference to FIG. 5, in this disclosure, the radio frequency circuit 30 may include a first radio frequency front end circuit (RFFEM) 311, a first frequency conversion circuit 312, a second radio frequency front end circuit 321, a second frequency conversion circuit 322, a first phase-locked loop (PLL) circuit 331, and a second phase-locked loop circuit 332.

The first phase-locked loop circuit 331 and the second phase-locked loop circuit 332 are designed with respect to a channel frequency, so that the two paths in the terminal device 1 simultaneously operate on the two channels or simultaneously operate on a same channel. Therefore, two Wi-Fi P2P connections on various channel combinations are supported between the terminal device 1 and another terminal device.

For example, both the terminal device 1 and a terminal device 2 may operate on a channel in a 2.4G band and a channel in the 2.4G band. Correspondingly, channels on two Wi-Fi P2P connections between the terminal device 1 and the terminal device 2 may be a combination of two channels in the 2.4G band and a channel in the 2.4G band.

For another example, both the terminal device 1 and the terminal device 2 may operate on a channel in a 5G band and a channel in the 5G band. Correspondingly, channels on two Wi-Fi P2P connections between the terminal device 1 and the terminal device 2 may be a combination of two channels in the 5G band and a channel in the 5G band.

For another example, both the terminal device 1 and the terminal device 2 may operate on a channel in a 6G band and a channel in the 6G band. Correspondingly, channels on two Wi-Fi P2P connections between the terminal device 1 and the terminal device 2 may be a combination of two channels in the 6G band and a channel in the 6G band.

For another example, both the terminal device 1 and the terminal device 2 may operate on a channel in a 2.4G band and a channel in a 5G band. Correspondingly, channels on two Wi-Fi P2P connections between the terminal device 1 and the terminal device 2 may be a combination of a channel in the 2.4G band and a channel in the 2.4G band, and a combination of a channel in the 5G band and a channel in the 5G band.

For another example, both the terminal device 1 and the terminal device 2 may operate on a channel in a 2.4G band and a channel in a 6G band. Correspondingly, channels on two Wi-Fi P2P connections between the terminal device 1 and the terminal device 2 may be a combination of a channel in the 2.4G band and a channel in the 2.4G band, and a combination of a channel in the 6G band and a channel in the 6G band.

For another example, both the terminal device 1 and the terminal device 2 may operate on a channel in a 5G band and a channel in a 6G band. Correspondingly, channels on two Wi-Fi P2P connections between the terminal device 1 and the terminal device 2 may be a combination of a channel in the 5G band and a channel in the 5G band, or a combination of a channel in the 6G band and a channel in the 6G band.

To simplify illustration, in FIG. 5, the first radio frequency front end circuit 311 is marked as RFFEM1, the first frequency conversion circuit 312 is marked as TRX1, the first ADC 41 is marked as ADC1, the first DAC 43 is marked as DAC1, the second radio frequency front end circuit 321 is marked as RFFEM2, the second frequency conversion circuit 322 is marked as TRX2, the second ADC 42 is marked as ADC2, the second DAC 44 is marked as DAC2, the first phase-locked loop circuit 331 is marked as PLL1, the second phase-locked loop circuit 332 is marked as PLL2, the radio frequency control circuit 63 is marked as RFC, the baseband sending circuit 61 is marked as BBTX, and the baseband receiving circuit 62 is marked as BBRX.

A first antenna 10 is connected to a common end of the first radio frequency front end circuit 311, a first end of the first radio frequency front end circuit 311 is connected to a first end of the first frequency conversion circuit 312, a second end of the first frequency conversion circuit 312 is connected to a first end of the first ADC 41, a second end of the first ADC 41 is connected to a first end of the baseband receiving circuit 62, a first end of the baseband sending circuit 61 is connected to a first end of the first DAC 43, and a second end of the first DAC 43 is connected to a third end of the first frequency conversion circuit 312.

A fourth end of the first frequency conversion circuit 312 is connected to the first phase-locked loop circuit 331, a fifth end of the first frequency conversion circuit 312 is connected to the second phase-locked loop circuit 332, and a sixth end of the first frequency conversion circuit 312 is connected to a second end of the radio frequency control circuit 63.

A second antenna 20 is connected to a common end of the second radio frequency front end circuit 321, a first end of the second radio frequency front end circuit 321 is connected to a first end of the second frequency conversion circuit 322, a second end of the second frequency conversion circuit 322 is connected to a first end of the second ADC 42, a second end of the second ADC 42 is connected to the first end of the switching switch 51, a second end of the baseband sending circuit 61 is connected to a first end of the second DAC 44, and a second end of the second DAC 44 is connected to a third end of the second frequency conversion circuit 322.

A fourth end of the second frequency conversion circuit 322 is connected to the second phase-locked loop circuit 332, a fifth end of the second frequency conversion circuit 322 is connected to the first phase-locked loop circuit 331, and a sixth end of the second frequency conversion circuit 322 is connected to a third end of the radio frequency control circuit 63.

The first contact point of the switching switch 51 is connected to a second end of the baseband receiving circuit 62, a fourth end of the single radio frequency multi-link control circuit 53 is connected to a third end of the baseband receiving circuit 62, and a fifth end of the single radio frequency multi-link control circuit 53 is connected to a third end of the baseband sending circuit 61.

Moreover, in addition to being connected to the first phase-locked loop circuit 331 and the second phase-locked loop circuit 332, the radio frequency control circuit 63 may be further separately connected to the first radio frequency front end circuit 311, the second radio frequency front end circuit 321, the first frequency conversion circuit 312, and the second frequency conversion circuit 322. Therefore, the radio frequency control circuit 63 is further configured to control bandwidths of the first radio frequency front end circuit 311, the second radio frequency front end circuit 321, the first frequency conversion circuit 312, and the second frequency conversion circuit 322 on respective channels.

A connection topology between the circuits may indicate that a logical connection relationship exists between the corresponding circuits.

The first radio frequency front end circuit 311 is configured to process a signal of an air interface of the first antenna 10, send the signal to the first frequency conversion circuit 312, process a signal transmitted by the first frequency conversion circuit 312, and transmit the signal through the first antenna 10.

The second radio frequency front end circuit 321 is configured to process a signal of an air interface of the second antenna 20, send the signal to the second frequency conversion circuit 322, process a signal transmitted by the second frequency conversion circuit 322, and transmit the signal through the second antenna 20.

Main components of the first radio frequency front end circuit 311 or the second radio frequency front end circuit 321 may include a filter, a power amplifier (PA), a radio frequency switch (switch/tuner), a low noise amplifier (LNA), and the like.

The first frequency conversion circuit 312 is configured to perform up-conversion processing on a signal output by the first radio frequency front end circuit 311, may convert an analog baseband signal into a radio frequency signal, and send the radio frequency signal to the first ADC 41. The first frequency conversion circuit 312 is further configured to perform down-conversion processing on a signal output by the first DAC 43, may convert a radio frequency signal into an analog baseband signal, and send the analog baseband signal to the first radio frequency front end circuit 311.

The second frequency conversion circuit 322 is configured to perform up-conversion processing on a signal output by the second radio frequency front end circuit 321, may convert an analog baseband signal into a radio frequency signal, and send the radio frequency signal to the second ADC 42. The second frequency conversion circuit 322 is further configured to perform down-conversion processing on a signal output by the second DAC 44, may convert a radio frequency signal into an analog baseband signal, and send the analog baseband signal to the second radio frequency front end circuit 321.

The first phase-locked loop circuit 331 is configured to output a local oscillator signal (also referred to as a local oscillator clock) used for frequency conversion processing to the first frequency conversion circuit 312, or output a same local oscillator signal used for frequency conversion processing to the first frequency conversion circuit 312 and the second frequency conversion circuit 322.

The second phase-locked loop circuit 332 is configured to output a local oscillator signal used for frequency conversion processing to the second frequency conversion circuit 322, or output a same local oscillator signal used for frequency conversion processing to the first frequency conversion circuit 312 and the second frequency conversion circuit 322.

The local oscillator signal mentioned above has a specific frequency, and corresponds to a frequency of a channel, for example, a frequency in a band to which the first channel belongs, or a frequency in a band to which the second channel belongs.

When a target channel is the first channel, the radio frequency control circuit 63 is further configured to control, based on a frequency of the target channel indicated by a first notification, the local oscillator signal output by the first phase-locked loop circuit 331, to configure the radio frequency circuits 30 on the first path and the second path to operate on the target channel.

Alternatively, when a target channel is the second channel, the radio frequency control circuit 63 is further configured to control, based on a frequency of the target channel indicated by a first notification, the local oscillator signal output by the second phase-locked loop circuit 332, to configure the radio frequency circuits 30 on the first path and the second path to operate on the target channel.

In addition, in some implementations, the radio frequency control circuit 63 is further configured to receive a third notification sent by the single radio frequency multi-link control circuit 53, and in response to the third notification, configure, based on a frequency of the first channel, the local oscillator signal output by the first phase-locked loop circuit 331, to configure the radio frequency circuit 30 on the first path to operate on the first channel, and configure, based on a frequency of the second channel, the local oscillator signal output by the second phase-locked loop circuit 332, to configure the radio frequency circuit 30 on the second path to operate on the second channel.

In some implementations, the radio frequency control circuit 63 is further configured to control, based on a frequency that is of the first channel and that is configured by default, the local oscillator signal output by the first phase-locked loop circuit 331, to configure the radio frequency circuit 30 on the first path to operate on the first channel; and control, based on a frequency that is of the second channel and that is configured by default, the local oscillator signal output by the second phase-locked loop circuit 332, to configure the radio frequency circuit 30 on the second path to operate on the second channel.

The baseband receiving circuit 62 is configured to perform processing such as demodulation and decoding on a signal transmitted by the first DAC 43, monitor the first channel, send the monitoring information of the first channel to the single radio frequency multi-link control circuit 53, and further receive a Wi-Fi frame.

In addition, the baseband receiving circuit 62 is further configured to send the second notification to the single radio frequency multi-link control circuit 53 after transmission of the service packet ends.

The baseband sending circuit 61 is further configured to receive a fourth notification sent by the single radio frequency multi-link control circuit 53, perform, based on the fourth notification, processing such as encoding and modulation on a signal corresponding to the service packet, and send a baseband signal to the first DAC 43 and/or the second DAC 44.

In addition, the fourth notification may alternatively be sent by another circuit in the terminal device 1 to the baseband sending circuit 61. This is not limited in this disclosure.

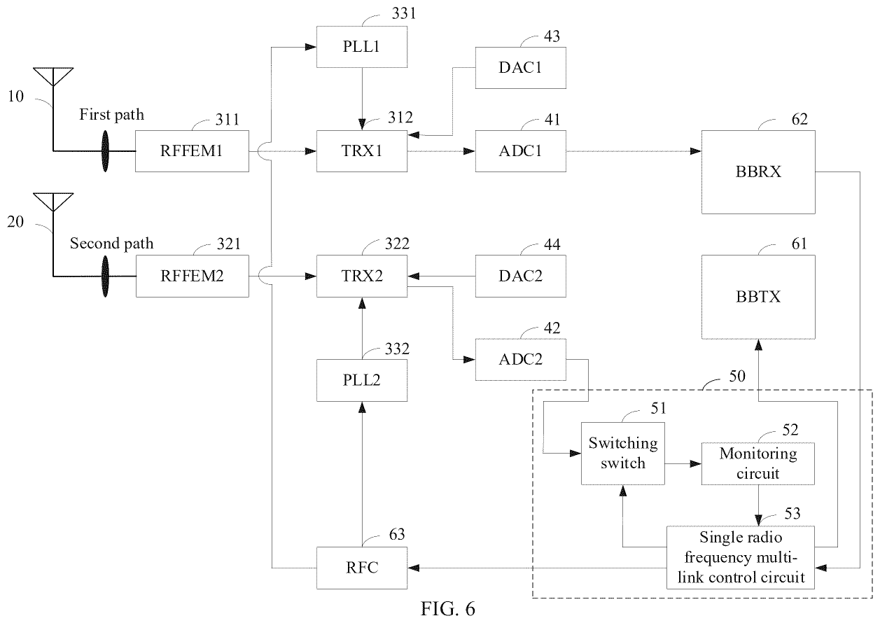

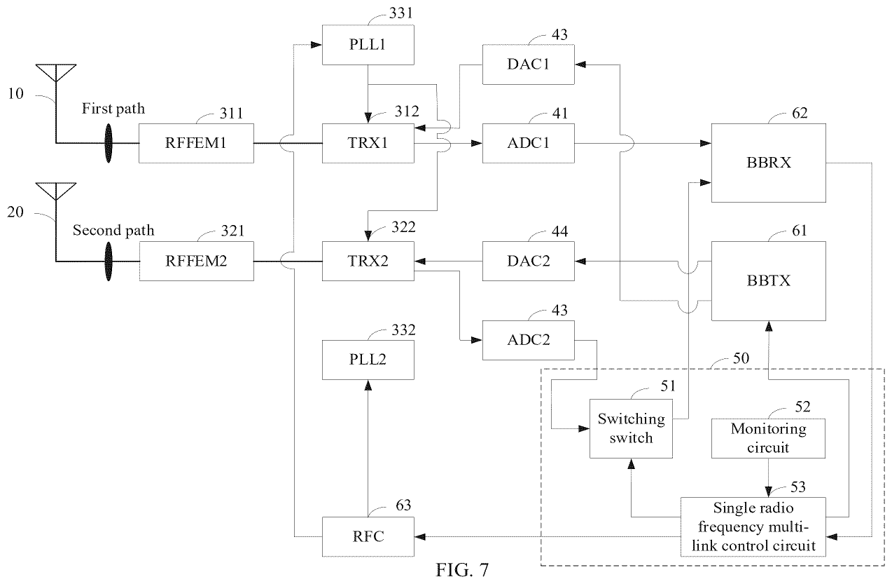

Based on the foregoing descriptions, with reference to FIG. 6 and FIG. 7, operating principles of the terminal device 1 in the channel monitoring phase and the service transmission phase are described in detail.

FIG. 6 is a diagram of connections of circuits of a terminal device in a channel monitoring phase according to an embodiment of this disclosure. FIG. 7 is a diagram of connections of circuits of a terminal device in a service transmission phase according to an embodiment of this disclosure.

As shown in FIG. 6, in the channel monitoring phase, a radio frequency control circuit 63 may control, based on a frequency of a first channel, a first phase-locked loop circuit 331 to output a local oscillator signal to a first frequency conversion circuit 312 on a first path. In this case, the first phase-locked loop circuit 331 is connected to the first frequency conversion circuit 312 on the first path, so that the first frequency conversion circuit 312 on the first path can be configured to operate on the first channel.

The radio frequency control circuit 63 may control, based on a frequency of a second channel, a second phase-locked loop circuit 332 to output a local oscillator signal to a second frequency conversion circuit 322 on a second path. In this case, the second phase-locked loop circuit 332 is connected to the second frequency conversion circuit 322 on the second path, so that the second frequency conversion circuit 322 on the second path can be configured to operate on the second channel.

A connection between a second ADC 42 and a baseband receiving circuit 62 is broken, and a connection between the second ADC 42 and a monitoring circuit 52 is established.

It can be learned that on the first path, a signal of a first antenna 10 on the first channel may be processed by a first radio frequency front end circuit 311, the first frequency conversion circuit 312, and a first ADC 41, and a baseband signal is output to the baseband receiving circuit 62.

The baseband receiving circuit 62 may perform physical carrier monitoring and virtual carrier monitoring on the first channel, to obtain monitoring information of the first channel. Therefore, the baseband receiving circuit 62 may send the monitoring information of the first channel to a single radio frequency multi-link control circuit 53.

On the second path, a signal of a second antenna 20 on the second channel may be processed by a second radio frequency front end circuit 321, the second frequency conversion circuit 322, and the second ADC 42, and a baseband signal is output to the monitoring circuit 52 through a switching switch 51.

The monitoring circuit 52 may perform physical carrier monitoring and virtual carrier monitoring on the second channel, to obtain monitoring information of the second channel. Therefore, the monitoring circuit 52 may send the monitoring information of the second channel to the single radio frequency multi-link control circuit 53.

As shown in FIG. 7, the single radio frequency multi-link control circuit 53 may determine a target channel based on the monitoring information of the first channel and the monitoring information of the second channel, and determine that the service transmission phase needs to be entered from the channel monitoring phase.

For ease of description, in FIG. 7, an example in which the target channel is the first channel is used for illustration.

The single radio frequency multi-link control circuit 53 may control the switching switch 51 to break the connection between the second ADC 42 and the baseband receiving circuit 62, establish the connection between the second ADC 42 and the monitoring circuit 52, send a first notification to the radio frequency control circuit 63, and send a fourth notification to the baseband sending circuit 61.

The radio frequency control circuit 63 may control, based on a frequency of the target channel indicated by the first notification, the first phase-locked loop circuit 331 to output the local oscillation signal to both the first frequency conversion circuit 312 on the first path and the second frequency conversion circuit 322 on the second path, and control the second phase-locked loop circuit 332 to stop outputting the local oscillation signal to the second frequency conversion circuit 322 on the second path. In this case, the first phase-locked loop circuit 331 is connected to both the first frequency conversion circuit 312 on the first path and the second frequency conversion circuit 322 on the second path, so that both the first frequency conversion circuit 312 on the first path and the second frequency conversion circuit 322 on the second path can be configured to operate on the target channel.

Therefore, the radio frequency control circuit 63 may configure both the first frequency conversion circuit 312 on the first path and the second frequency conversion circuit 322 on the second path to operate on a same channel.

In the service transmission phase, on the first path, a signal corresponding to a Wi-Fi frame of the first antenna 10 on the target channel may be processed by the first radio frequency front end circuit 311, the first frequency conversion circuit 312, and the first ADC 41, and a baseband signal is output to the baseband receiving circuit 62.

A signal of a service packet is processed by the baseband sending circuit 61, then processed by the first DAC 43, the first frequency conversion circuit 312, and the first radio frequency front end circuit 311, and transmitted through the first antenna 10, and/or on the second path, a signal corresponding to a Wi-Fi frame of the second antenna 20 on the target channel may be processed by the second radio frequency front end circuit 321, the second frequency conversion circuit 322, and the second ADC 42, and a baseband signal is output to the baseband receiving circuit 62 through the switching switch 51.

A signal of a service packet is processed by the baseband sending circuit 61, then processed by a second DAC 44, the second frequency conversion circuit 322, and the second radio frequency front end circuit 321, and transmitted through the second antenna 20.

In addition, after receiving an acknowledgment control frame sent by another terminal device or obtaining an acknowledgment control frame generated by the terminal device 1, the baseband receiving circuit 62 may send a second notification to the single radio frequency multi-link control circuit 53.

The single radio frequency multi-link control circuit 53 may determine, based on the second notification, that transmission of the service packet ends. Therefore, the single radio frequency multi-link control circuit 53 may control the switching switch 51 to break the connection between the second ADC 42 and the baseband receiving circuit 62, establish the connection between the second ADC 42 and the monitoring circuit 52, and send a third notification to the radio frequency control circuit 63.

In response to the third notification, the radio frequency control circuit 63 may control, based on the frequency of the first channel, the first phase-locked loop circuit 331 to output the local oscillator signal to the first frequency conversion circuit 312 on the first path. In this case, the first phase-locked loop circuit 331 is connected to the first frequency conversion circuit 312 on the first path, so that the first frequency conversion circuit 312 on the first path can be configured to operate on the first channel. The radio frequency control circuit 63 may control, based on the frequency of the second channel, the second phase-locked loop circuit 332 to output the local oscillator signal to the second frequency conversion circuit 322 on the second path. In this case, the second phase-locked loop circuit 332 is connected to the second frequency conversion circuit 322 on the second path, so that the second frequency conversion circuit 322 on the second path can be configured to operate on the second channel.

Based on the descriptions of the embodiments in FIG. 5 to FIG. 7, in the channel monitoring phase, local oscillator signals output by two phase-locked loop circuits are separately configured, so that two frequency conversion circuits on the first path and the second path can operate on two channels. In addition, the baseband receiving circuit 62 and the monitoring circuit 52 separately perform channel state monitoring, control frame detection, and the like on the two channels on the first path and the second path.

In the service transmission phase, when one channel is selected from the two channels for performing transmission of the service packet, the radio frequency control circuit 63 configures a local oscillator signal output by a phase-locked loop circuit corresponding to the channel, so that the two paths can perform transmission of (send or receive) a signal on the channel, to implement sending and receiving of the 2×2 MIMO capability.

Based on the descriptions of the foregoing embodiments, in a packet sending scenario in which the terminal device 1 executes a delay-sensitive service, the terminal device 1 may encounter various cases. To cope with the various cases, the terminal device 1 may determine the target channel from the first channel and the second channel in a plurality of implementations.

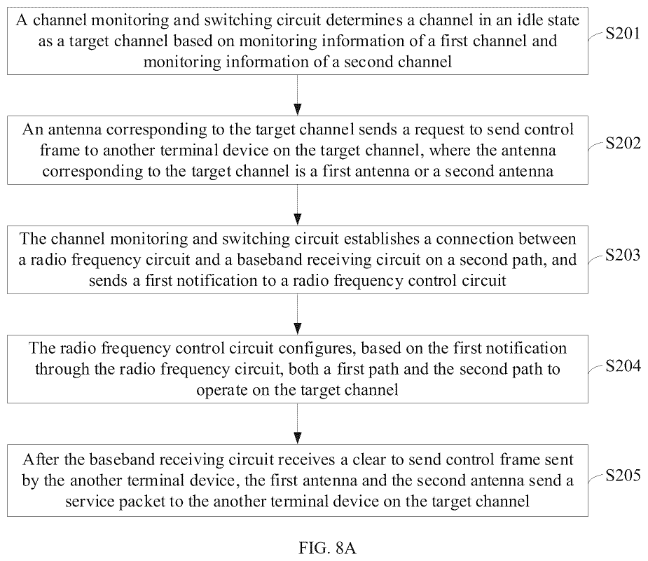

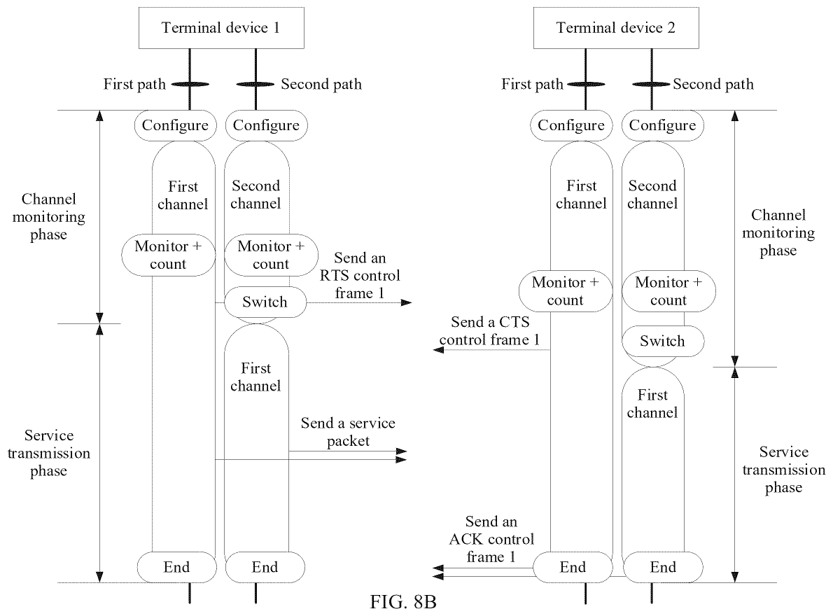

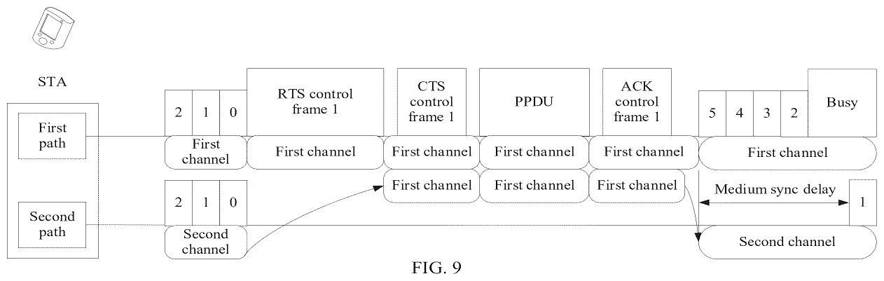

With reference to FIG. 8A, FIG. 8B and FIG. 9, the following describes an implementation in which a terminal device 1 determines a target channel.

FIG. 8A and FIG. 8B are schematic flowcharts of a P2P communication method according to an embodiment of this disclosure. To simplify illustration, in FIG. 8B, an example in which a target channel is a first channel is used for illustration.

As shown in FIG. 8A and FIG. 8B, the P2P communication method in this disclosure may include the following steps.

S201: A channel monitoring and switching circuit determines a channel in an idle state as the target channel based on monitoring information of the first channel and monitoring information of a second channel.

In a packet sending scenario of a terminal device 1, a single radio frequency multi-link control circuit 53 may detect whether there is a service packet in a cache queue of the terminal device 1.

If there is no service packet in the cache queue of the terminal device 1, the single radio frequency multi-link control circuit 53 may determine that the terminal device 1 does not need to send the service packet, and may discard the monitoring information of the first channel and the monitoring information of the second channel. The single radio frequency multi-link control circuit 53 may notify a baseband receiving circuit 62 to continue to monitor the first channel, and a monitoring circuit 52 to continue to monitor the second channel.

If there is the service packet in the cache queue of the terminal device 1, the single radio frequency multi-link control circuit 53 may determine that the terminal device 1 needs to send the service packet. Further, the single radio frequency multi-link control circuit 53 may start a backoff (BO) counter to perform counting, determine the channel in the idle state as the target channel from the first channel and the second channel based on the monitoring information of the first channel and the monitoring information of the second channel, and select the target channel to perform channel contention.

S202: An antenna corresponding to the target channel sends a RTS control frame to another terminal device on the target channel, where the antenna corresponding to the target channel is a first antenna or a second antenna.

The RTS control frame is represented by using an RTS control frame 1.

The single radio frequency multi-link control circuit 53 may send a fourth notification to a baseband sending circuit 61. In response to the fourth notification, the baseband sending circuit 61 may send the RTS control frame 1 to the another terminal device on the target channel on a path corresponding to the target channel through the antenna corresponding to the target channel.

Specifically, on the path corresponding to the target channel, the RTS control frame 1 is processed by the baseband sending circuit 61, then processed by a digital-to-analog converter corresponding to the target channel, a frequency conversion circuit corresponding to the target channel, and a radio frequency front end circuit corresponding to the target channel, and a signal is transmitted through the antenna corresponding to the target channel.

The RTS control frame 1 indicates that the terminal device 1 sends the service packet on the target channel. A specific implementation of the RTS control frame 1 is not limited in this disclosure.

When the target channel is the first channel, the first channel is idle, and the antenna corresponding to the target channel is the first antenna 10. Based on this, on the first path, the RTS control frame 1 is processed by the baseband sending circuit 61, a first DAC 43, a first frequency conversion circuit 312, and a first radio frequency front end circuit 311, and a signal is transmitted through the first antenna 10.

Alternatively, when the target channel is the second channel, the second channel is idle, and the antenna corresponding to the target channel is the second antenna 20. Based on this, on the second path, the RTS control frame 1 is processed by the baseband sending circuit 61, a second DAC 44, a second frequency conversion circuit 322, and a second radio frequency front end circuit 321, and a signal is transmitted through the second antenna 20.

Therefore, the terminal device 1 may send the RTS control frame 1 to the another terminal device on the target channel on the path corresponding to the target channel through the antenna corresponding to the target channel, so that the another terminal device learns, based on the RTS control frame 1, that the terminal device 1 needs to send the service packet on the target channel.

S203: The channel monitoring and switching circuit establishes a connection between a radio frequency circuit and the baseband receiving circuit on the second path, and sends a first notification to a radio frequency control circuit.

The terminal device 1 needs to send another service packet. Based on this, the single radio frequency multi-link control circuit 53 may control a switching switch 51 to establish a connection between a second ADC 42 and the baseband receiving circuit 62, break a connection between the second ADC 42 and the monitoring circuit 52, and send the first notification to the radio frequency control circuit 63.

It should be understood that S202 and S203 are not subject to a time sequence, and S202 and S203 may be simultaneously performed, or may be sequentially performed.

S204: The radio frequency control circuit configures, based on the first notification through the radio frequency circuit, both the first path and the second path to operate on the target channel.

When the target channel is the first channel, the radio frequency control circuit 63 controls, based on a frequency of the target channel indicated by the first notification, a first phase-locked loop circuit 331 to output a local oscillator signal to both the first frequency conversion circuit 312 on the first path and the second frequency conversion circuit 322 on the second path. In this case, the first phase-locked loop circuit 331 is connected to both the first frequency conversion circuit 312 on the first path and the second frequency conversion circuit 322 on the second path, so that both the first frequency conversion circuit 312 on the first path and the second frequency conversion circuit 322 on the second path operate on the target channel.

Alternatively, when the target channel is the second channel, the radio frequency control circuit 63 controls, based on a frequency of the target channel indicated by the first notification, a second phase-locked loop circuit 332 to output a local oscillator signal to both the first frequency conversion circuit 312 on the first path and the second frequency conversion circuit 322 on the second path. In this case, the second phase-locked loop circuit 332 is connected to both the first frequency conversion circuit 312 on the first path and the second frequency conversion circuit 322 on the second path, so that both the first frequency conversion circuit 312 on the first path and the second frequency conversion circuit 322 on the second path operate on the target channel.

Therefore, the radio frequency control circuit 63 may configure both the first frequency conversion circuit 312 on the first path and the second frequency conversion circuit 322 on the second path to operate on the target channel.

S205: After the baseband receiving circuit receives a clear to send control frame sent by the another terminal device, the first antenna and the second antenna send a service packet to the another terminal device on the target channel.

The clear to send control frame is represented by using a CTS control frame 1.

When receiving the RTS control frame 1, the another terminal device may determine whether the another terminal device allows the terminal device 1 to send the service packet to the another terminal device.

If the another terminal device allows the terminal device 1 to send the service packet to the another terminal device, the another terminal device may send, to the terminal device 1 on the target channel, the CTS control frame 1 corresponding to the RTS control frame 1. Correspondingly, the terminal device 1 may receive the CTS control frame 1 on the target channel through the first antenna 10 on the first path and the second antenna 20 on the second path. When receiving the CTS control frame, the terminal device 1 may determine that the another terminal device allows the terminal device 1 to send the service packet to the another terminal device.

Therefore, the terminal device 1 may send the service packet to the another terminal device on the target channel through the first antenna 10 on the first path and the second antenna 20 on the second path.

If the another terminal device does not allow the terminal device 1 to send the service packet to the another terminal device, the another terminal device may discard the RTS control frame 1. Correspondingly, the terminal device 1 cannot receive the CTS control frame 1 on the target channel through the first antenna 10 and the second antenna 20.

Therefore, the terminal device 1 cannot send the service packet to the another terminal device. In this case, the terminal device 1 may continue to attempt to send the RTS control frame 1 to the another terminal device, or may abandon sending the service packet to the another terminal device.

The CTS control frame 1 indicates that the another terminal device allows the terminal device 1 to send the service packet on the target channel. A specific implementation of the CTS control frame 1 is not limited in this disclosure.

It should be understood that, when the terminal device 1 receives the CTS control frame 1, both the first frequency conversion circuit 312 on the first path and the second frequency conversion circuit 322 on the second path have operated on the target channel. Therefore, the terminal device 1 may receive the CTS control frame 1 on the target channel on the first path and the second path through the first antenna 10 on the first path and the second antenna 20 on the second path.

In a specific implementation, with reference to FIG. 9, a specific implementation process in which the terminal device 1 sends a service packet to a terminal device 2 is described in detail by using an example in which the terminal device 1 is a STA, a Wi-Fi P2P connection between the terminal device 1 and the terminal device 2 is link1, and a Wi-Fi P2P connection between the terminal device 1 and the terminal device 2 is link2.

FIG. 9 is a diagram of a service packet transmission scenario of a terminal device according to an embodiment of this disclosure.

As shown in FIG. 9, the P2P communication method in this disclosure may include the following steps.

Step 11: A first path in a STA performs monitoring on link1 and starts a BO counter to perform counting, and a second path in the STA performs monitoring on link2 and starts a BO counter to perform counting.

A channel on link1 is a first channel, and a channel on link2 is a second channel.

The BO counter may count down starting from a random number. A specific value of the random number is not limited in this disclosure. For ease of description, in FIG. 9, an example in which the BO counter counts down starting from 2 is used for illustration.

Step 12: When counting of the BO counter expires, the STA selects an idle channel from the channel on link1 and the channel on link2 as a target channel. For ease of description, an example in which the target channel is the first channel corresponding to link1 is used for description.

Step 13: The first path in the STA sends an RTS control frame 1 on link1, and simultaneously configures, through a first phase-locked loop circuit 331, a second frequency conversion circuit 322 on the second path to perform channel switching, that is, switch the channel on link2 from the second channel to the first channel. In addition, the channel on link1 is kept as the first channel.

Step 14: The STA receives a CTS control frame 1, sends a physical layer protocol data unit (PPDU) (that is, a service packet), and receives an ACK control frame 1 on link1 and link2.

The ACK control frame 1 is an acknowledgment control frame sent by a terminal device 2 to a terminal device 1.

Step 15: When receiving the ACK control frame 1, the STA configures, through a second phase-locked loop circuit 332, a second frequency conversion circuit 322 on the second path to perform channel switching, that is, switch the channel on link2 from the first channel to the second channel. In addition, the channel on link1 is kept as the first channel. In this way, subsequent channel monitoring is facilitated.

Step 16: The first path in the STA re-performs monitoring on link1 and starts the BO counter to perform counting.

The channel on link1 is the first channel.

The BO counter may re-count down starting from a random number. A specific value of the random number is not limited in this disclosure. For ease of description, in FIG. 9, an example in which the BO counter counts down starting from 5 and the first channel on link1 is busy when timing is performed to 1 is used for illustration.

After the channel of the second path in the STA on link2 is switched from the first channel to the second channel, the STA needs to keep monitoring the second channel on link2 for a period of time (medium sync delay), to resume virtual carrier monitoring on the second channel. Therefore, the second path in the STA re-performs monitoring on link2 and starts the BO counter to perform counting.

The BO counter may count down starting from a random number. A specific value of the random number is not limited in this disclosure. For ease of description, in FIG. 9, an example in which the BO counter counts down starting from 1 is used for illustration.

Based on the descriptions of the embodiments in FIG. 8A, FIG. 8B and FIG. 9, in the service packet transmission scenario, the single radio frequency multi-link control circuit 53 may detect whether the terminal device 1 needs to send the service packet. If the terminal device 1 needs to send the service packet, the single radio frequency multi-link control circuit 53 selects the idle channel from the first channel and the second channel as the target channel. The single radio frequency multi-link control circuit 53 may configure the two frequency conversion circuits and control the switching switch 51 to configure both the first antenna 10 and the second antenna 20 to operate on the target channel. Therefore, when the another terminal device determines to receive the service packet sent by the terminal device 1, the terminal device 1 may send the service packet to the another terminal device on the target channel through the first antenna 10 and the second antenna 20, so that sending and receiving of the 2×2 MIMO capability can be implemented.

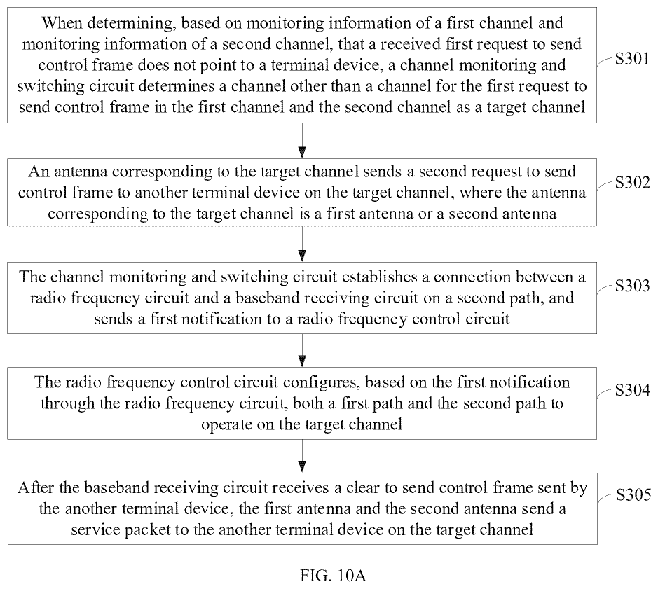

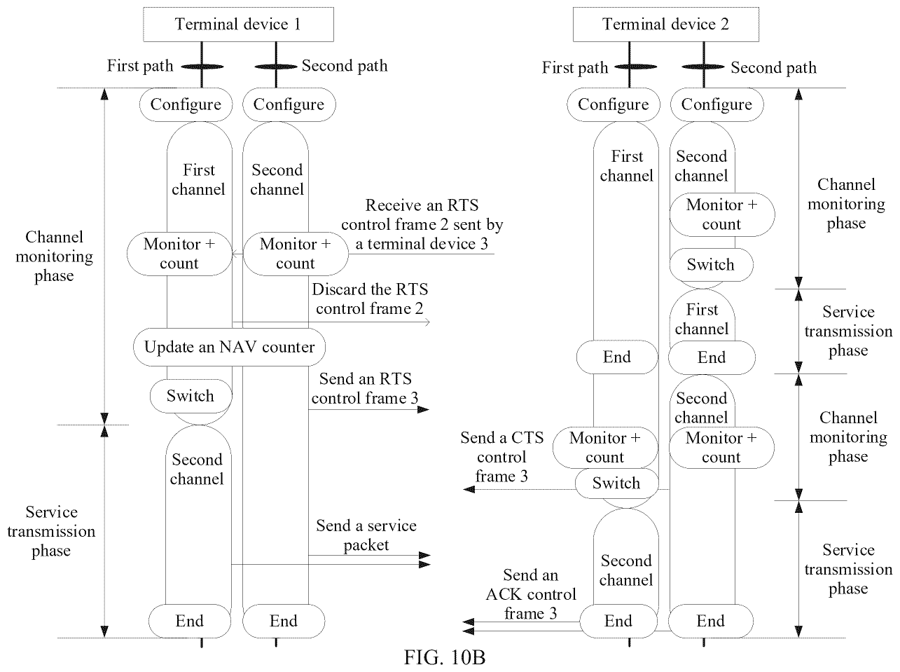

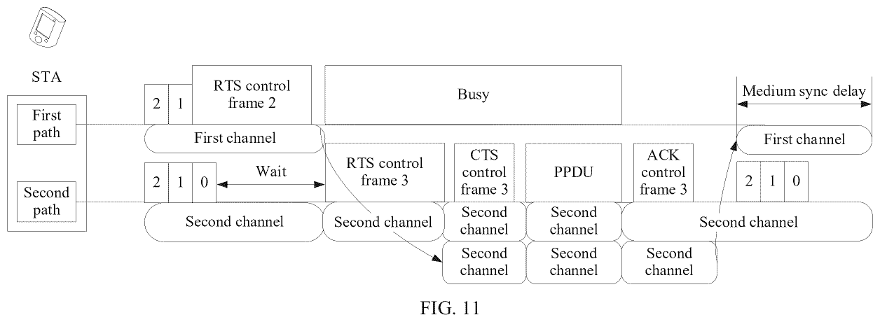

With reference to FIG. 10A, FIG. 10B and FIG. 11, the following describes an implementation in which a terminal device 1 determines a target channel.

FIG. 10A and FIG. 10B are schematic flowcharts of a P2P communication method according to an embodiment of this disclosure. To simplify illustration, in FIG. 10B, an example in which a target channel is a second channel is used for illustration.

As shown in FIG. 10A and FIG. 10B, the P2P communication method in this disclosure may include the following steps.

S301: When determining, based on monitoring information of a first channel and monitoring information of the second channel, that a received first RTS control frame does not point to a terminal device, a channel monitoring and switching circuit determines a channel other than a channel for the first RTS control frame in the first channel and the second channel as the target channel.

The first RTS control frame is represented by using an RTS control frame 2.

When detecting the RTS control frame 2, a single radio frequency multi-link control circuit 53 may parse the RTS control frame 2 based on the monitoring information of the first channel and the monitoring information of the second channel.

The RTS control frame 2 indicates a destination address of a service packet on a channel for the RTS control frame 2. A specific implementation of the RTS control frame 2 is not limited in this disclosure. For example, the RTS control frame 2 may carry the destination address.

When the destination address of the service packet indicated by the RTS control frame 2 does not point to the terminal device 1, the single radio frequency multi-link control circuit 53 may determine a channel other than the channel for the RTS control frame 2 in the first channel and the second channel as the target channel, and select the target channel to perform channel contention.

When the channel for the RTS control frame 2 is the first channel, the target channel is the second channel.

Alternatively, when the channel for the RTS control frame 2 is the second channel, the target channel is the first channel.

Therefore, the single radio frequency multi-link control circuit 53 may discard the RTS control frame 2.

In addition, another terminal device that sends the RTS control frame 2 and another terminal device that receives a service packet sent by the terminal device 1 are different terminal devices. In other words, if the terminal device 1 sends a service packet to a terminal device 2, the RTS control frame 2 is received by the terminal device 1 from a terminal device 3, and the terminal device 2 and the terminal device 3 are different terminal devices.

S302: An antenna corresponding to the target channel sends a second RTS control frame to the another terminal device on the target channel, where the antenna corresponding to the target channel is a first antenna or a second antenna.

The second RTS control frame is represented by using an RTS control frame 3.

The terminal device 1 needs to send the service packet. Based on this, the single radio frequency multi-link control circuit 53 may send a fourth notification to a baseband sending circuit 61. In response to the fourth notification, the baseband sending circuit 61 may send the RTS control frame 3 to the another terminal device on the target channel on a path corresponding to the target channel through the antenna corresponding to the target channel.

The another terminal device is not a terminal device that sends the RTS control frame 2.

Specifically, on the path corresponding to the target channel, the RTS control frame 3 is processed by the baseband sending circuit 61, then processed by a digital-to-analog converter corresponding to the target channel, a frequency conversion circuit corresponding to the target channel, and a radio frequency front end circuit corresponding to the target channel, and a signal is transmitted through the antenna corresponding to the target channel.

The RTS control frame 3 indicates that the terminal device 1 sends the service packet on the target channel. A specific implementation of the RTS control frame 3 is not limited in this disclosure.

When the target channel is the first channel, the antenna corresponding to the target channel is the first antenna 10. Based on this, on the first path, the RTS control frame 3 is processed by the baseband sending circuit 61, a first DAC 43, a first frequency conversion circuit 312, and a first radio frequency front end circuit 311, and a signal is transmitted through the first antenna 10.

Alternatively, when the target channel is the second channel, the antenna corresponding to the target channel is the second antenna 20. Based on this, on the second path, the RTS control frame 3 is processed by the baseband sending circuit 61, a second DAC 44, a second frequency conversion circuit 322, and a second radio frequency front end circuit 321, and a signal is transmitted through the second antenna 20.

Therefore, the terminal device 1 may send the RTS control frame 3 to the another terminal device on the target channel on the path corresponding to the target channel through the antenna corresponding to the target channel, so that the another terminal device learns, based on the RTS control frame 3, that the terminal device 1 needs to send the service packet on the target channel.

In addition, based on the descriptions of S302, the another terminal device corresponding to the RTS control frame 2 and the another terminal device corresponding to the RTS control frame 3 are different terminal devices.

S303: The channel monitoring and switching circuit establishes a connection between a radio frequency circuit and a baseband receiving circuit on the second path, and sends a first notification to a radio frequency control circuit.

The terminal device 1 needs to send the service packet. Based on this, the single radio frequency multi-link control circuit 53 may control a switching switch 51 to establish a connection between a second ADC 42 and the baseband receiving circuit 62, break a connection between the second ADC 42 and a monitoring circuit 52, and send the first notification to the radio frequency control circuit 63.

It should be understood that S302 and S303 are not subject to a time sequence, and S302 and S303 may be simultaneously performed, or may be sequentially performed.

S304: The radio frequency control circuit configures, based on the first notification through the radio frequency circuit, both the first path and the second path to operate on the target channel.

When the target channel is the first channel, the radio frequency control circuit 63 controls, based on a frequency of the first channel indicated by the first notification, a first phase-locked loop circuit 331 to output a local oscillator signal to both the first frequency conversion circuit 312 on the first path and the second frequency conversion circuit 322 on the second path. In this case, the first phase-locked loop circuit 331 is connected to both the first frequency conversion circuit 312 on the first path and the second frequency conversion circuit 322 on the second path, so that both the first frequency conversion circuit 312 on the first path and the second frequency conversion circuit 322 on the second path operate on the first channel.

Alternatively, when the target channel is the second channel, the radio frequency control circuit 63 controls, based on a frequency of the second channel indicated by the first notification, a second phase-locked loop circuit 332 to output a local oscillator signal to both the first frequency conversion circuit 312 on the first path and the second frequency conversion circuit 322 on the second path. In this case, the second phase-locked loop circuit 332 is connected to both the first frequency conversion circuit 312 on the first path and the second frequency conversion circuit 322 on the second path, so that both the first frequency conversion circuit 312 on the first path and the second frequency conversion circuit 322 on the second path operate on the second channel.

Therefore, the radio frequency control circuit 63 may configure both the first frequency conversion circuit 312 on the first path and the second frequency conversion circuit 322 on the second path to operate on the target channel.

S305: After the baseband receiving circuit receives a clear to send control frame sent by the another terminal device, the first antenna and the second antenna send a service packet to the another terminal device on the target channel.

The clear to send control frame is represented by using a CTS control frame 3.

When receiving the RTS control frame 3, the another terminal device may determine whether the another terminal device allows the terminal device 1 to send the service packet to the another terminal device.

If the another terminal device allows the terminal device 1 to send the service packet to the another terminal device, the another terminal device may send, to the terminal device 1 on the target channel, the CTS control frame 3 corresponding to the RTS control frame 3. Correspondingly, the terminal device 1 may receive the CTS control frame 3 on the target channel through the first antenna 10 on the first path and the second antenna 20 on the second path. When receiving the CTS control frame 3, the terminal device 1 may determine that the another terminal device allows the terminal device 1 to send the service packet to the another terminal device.

Therefore, the terminal device 1 may send the service packet to the another terminal device on the target channel through the first antenna 10 on the first path and the second antenna 20 on the second path.

If the another terminal device does not allow the terminal device 1 to send the service packet to the another terminal device, the another terminal device may discard the RTS control frame 3. Correspondingly, the terminal device 1 cannot receive the CTS control frame 3 on the target channel through the first antenna 10 on the first path and the second antenna 20 on the second path.

Therefore, the terminal device 1 cannot send the service packet to the another terminal device. In this case, the terminal device 1 may continue to attempt to send the RTS control frame 3 to the another terminal device, or may abandon sending the service packet to the another terminal device.

The CTS control frame 3 indicates that the another terminal device allows the terminal device 1 to send the service packet on the target channel. A specific implementation of the CTS control frame 3 is not limited in this disclosure.

In a specific implementation, with reference to FIG. 11, a specific implementation process in which the terminal device 1 sends a service packet to the terminal device 2 is described in detail by using an example in which the terminal device 1 is a STA, a Wi-Fi P2P connection between the terminal device 1 and the terminal device 2 is link1, and a Wi-Fi P2P connection between the terminal device 1 and the terminal device 2 is link2.

FIG. 11 is a diagram of a service packet transmission scenario of a terminal device according to an embodiment of this disclosure.

As shown in FIG. 11, the P2P communication method in this disclosure may include the following steps.

Step 21: A first path in a STA performs monitoring on link1 and starts a BO counter to perform counting, and a second path in the STA performs monitoring on link2 and starts a BO counter to perform counting.

A channel on link1 is a first channel, and a channel on link2 is a second channel.

The BO counter may count down starting from a random number. A specific value of the random number is not limited in this disclosure. For ease of description, in FIG. 11, an example in which the BO counter counts down starting from 2 is used for illustration.

Step 22: In a counting process of the BO counter (in FIG. 11, timing to 1 is used for illustration), the STA determines that an RTS control frame 2 is received on link1, and may parse the RTS control frame 2, and compare whether a destination address of a service packet points to the STA.

Step 23: In a process of processing the RTS control frame 2, even if counting of the BO counter on link2 expires, the STA still needs to wait, and cannot trigger sending of a service packet.

Step 24: When determining that the destination address does not point to the STA, the STA discards the RTS control frame 2, and updates a network allocation vector (NAV) counter based on duration information in the RTS control frame 2. Therefore, the STA may continue to send a service packet to a terminal device 2.

It should be understood that the RTS control frame 2 is not sent by the terminal device 2 to the terminal device 1, but is sent by a terminal device 3 to the terminal device 1.

Step 25: The STA marks the first channel on link1 as busy, marks the second channel on link2 as idle, sends an RTS control frame 3 on the second path in the STA on link2, and simultaneously configures, through a second phase-locked loop circuit 332, a first frequency conversion circuit 312 on the first path to perform channel switching, that is, switch the channel on link1 from the first channel to the second channel. In addition, the channel on link2 is kept as the second channel.

Step 26: The STA receives a CTS control frame 3, sends a PPDU, and receives an ACK control frame 3 on link1 and link2. The ACK control frame 3 is an acknowledgment control frame sent by the terminal device 2 to the terminal device 1.

Step 27: After receiving the ACK control frame 3, the STA configures, through a first phase-locked loop circuit 331, the first frequency conversion circuit 312 on the first channel to perform channel switching, that is, switch the channel on link1 from the second channel to the first channel. In addition, the channel on link2 is kept as the second channel. In this way, subsequent channel monitoring is facilitated.

Step 28: After the channel of the first path in the STA on link1 is switched from the second channel to the first channel, the STA needs to keep monitoring the first channel on link1 for a period of time (medium sync delay), to resume virtual carrier monitoring on the first channel. Therefore, the first path in the STA re-performs monitoring on link1 and starts the BO counter to perform counting (not shown in FIG. 11).

The second path in the STA re-performs monitoring on link2, and starts the BO counter to perform counting.

The BO counter may re-count down starting from a random number. A specific value of the random number is not limited in this disclosure. For ease of description, in FIG. 11, an example in which the BO counter counts down starting from 2 is used for illustration.

Based on the descriptions of the embodiments in FIG. 10A, FIG. 10B, and FIG. 11, in the service packet transmission scenario, the single radio frequency multi-link control circuit 53 may detect whether the terminal device 3 sends a service packet on the first channel and/or the second channel. When the terminal device 3 does not send the service packet to the terminal device 1, the single radio frequency multi-link control circuit 53 uses a channel other than a channel for a request sent by the terminal device 3 as the target channel. The single radio frequency multi-link control circuit 53 may configure the two frequency conversion circuits and control the switching switch 51 to configure both the first antenna 10 and the second antenna 20 to operate on the target channel. Therefore, the terminal device 1 sends the service packet to the terminal device 2 on the target channel through the first antenna 10 and the second antenna 20, so that sending and receiving of the 2×2 MIMO capability can be implemented.

With reference to FIG. 10A, FIG. 10B, and FIG. 11, in a packet sending scenario in which the terminal device 1 executes a delay-sensitive service, the terminal device 1 may receive a request for sending a service packet from another terminal device, that is, the another terminal device needs to send the service packet to the terminal device 1. Based on this, the terminal device 1 may change from the packet sending scenario to a receiving scenario, that is, the terminal device 1 needs to first receive the service packet sent by the another terminal device, and then send the service packet to the another terminal device.

The another terminal device that sends the service packet to the terminal device 1 may be the same as or different from the another terminal device that receives the service packet sent by the terminal device 1.

A specific implementation in which the terminal device 1 sends the service packet to the another terminal device may be the manner shown in FIG. 8A, FIG. 8B, and FIG. 9, or may be the manner shown in FIG. 10A, FIG. 10B, and FIG. 11. Details are not described herein again.

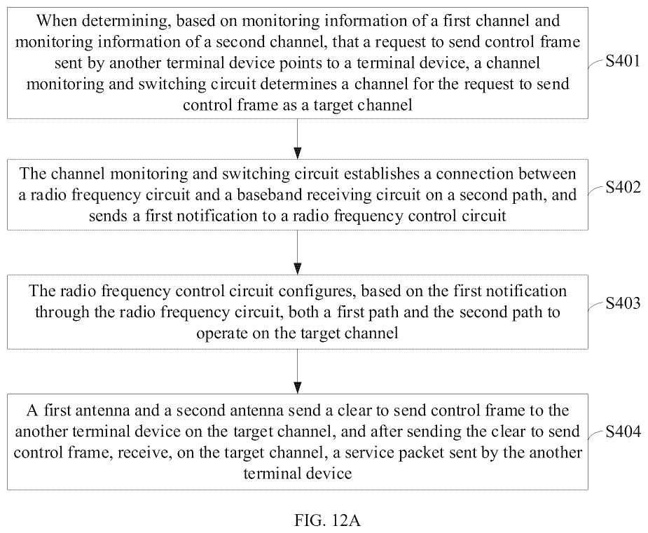

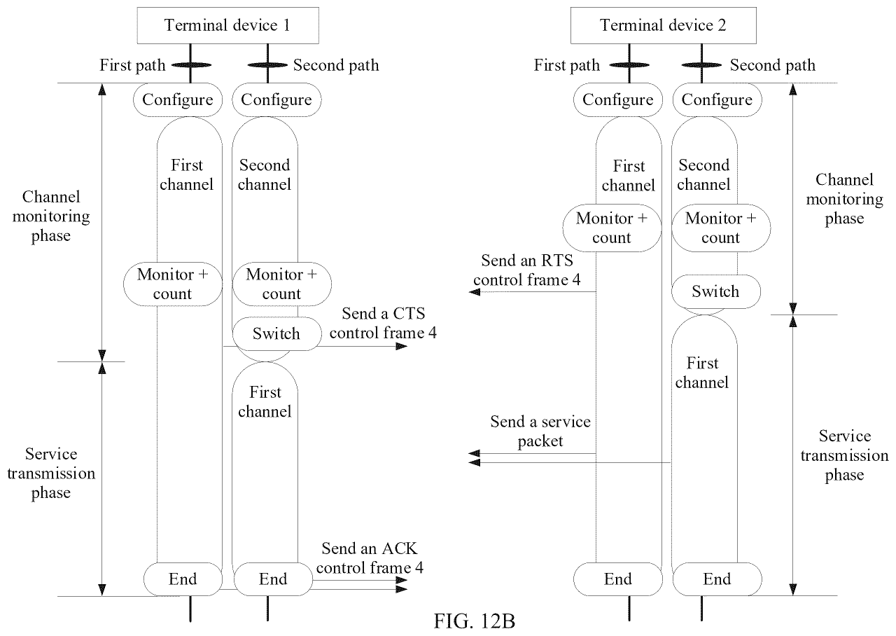

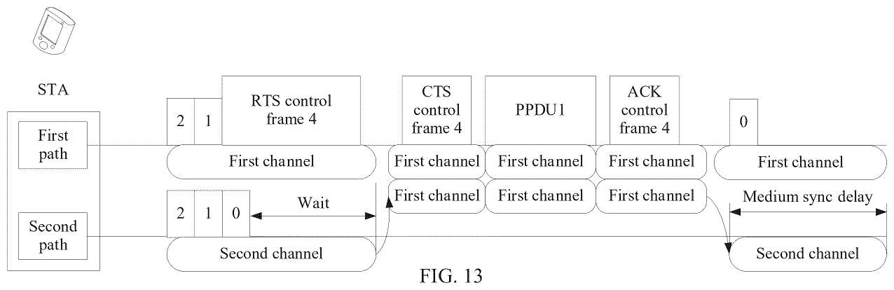

With reference to FIG. 12A, FIG. 12B, and FIG. 13, the following describes an implementation in which a terminal device 1 determines a target channel when receiving a service packet.

FIG. 12A and FIG. 12B are schematic flowcharts of a P2P communication method according to an embodiment of this disclosure. To simplify illustration, in FIG. 12B, an example in which a target channel is a first channel is used for illustration.

As shown in FIG. 12A and FIG. 12B, the P2P communication method in this disclosure may include the following steps.

S401: When determining, based on monitoring information of the first channel and monitoring information of a second channel, that a received RTS control frame points to a terminal device, a channel monitoring and switching circuit determines a channel for the RTS control frame as the target channel.

The RTS control frame is represented by using an RTS control frame 4.

When detecting that the RTS control frame 4 is received, a single radio frequency multi-link control circuit 53 may parse the RTS control frame 4 based on the monitoring information of the first channel and the monitoring information of the second channel.

The RTS control frame 4 indicates a destination address (RA) of a service packet on a channel for the RTS control frame 4. A specific implementation of the RTS control frame 4 is not limited in this disclosure. For example, the RTS control frame 4 may carry the destination address of the service packet.

When the destination address of the service packet indicated by the RTS control frame 4 points to the terminal device 1, the single radio frequency multi-link control circuit 53 may determine that the terminal device 1 needs to receive, on the channel for the RTS control frame 4, a service packet sent by another terminal device.

Therefore, the single radio frequency multi-link control circuit 53 may determine the channel for the RTS control frame 4 in the first channel and the second channel as the target channel, and select the target channel to perform channel contention.

When the channel for the RTS control frame 4 is the first channel, the target channel is the first channel.

Alternatively, when the channel for the RTS control frame 4 is the second channel, the target channel is the second channel.

In addition, another terminal device that sends the RTS control frame 4 and another terminal device that receives a service packet sent by the terminal device 1 may be a same terminal device or different terminal devices. In other words, if the terminal device 1 sends a service packet to a terminal device 2, the RTS control frame 4 may be received by the terminal device 1 from the terminal device 2, or the RTS control frame 4 may be received by the terminal device 1 from a terminal device 3. The terminal device 2 and the terminal device 3 are different terminal devices.

S402: The channel monitoring and switching circuit establishes a connection between a radio frequency circuit and a baseband receiving circuit on a second path, and sends a first notification to a radio frequency control circuit.

The terminal device 1 needs to receive another service packet. Based on this, the single radio frequency multi-link control circuit 53 may control a switching switch 51 to establish a connection between a second ADC 42 and the baseband receiving circuit 62, break a connection between the second ADC 42 and a monitoring circuit 52, and send the first notification to the radio frequency control circuit 63.

S403: The radio frequency control circuit configures, based on the first notification through the radio frequency circuit, both a first path and the second path to operate on the target channel.

When the target channel is the first channel, the radio frequency control circuit 63 controls, based on a frequency of the first channel indicated by the first notification, a first phase-locked loop circuit 331 to output a local oscillator signal to both a first frequency conversion circuit 312 on the first path and a second frequency conversion circuit 322 on the second path. In this case, the first phase-locked loop circuit 331 is connected to both the first frequency conversion circuit 312 on the first path and the second frequency conversion circuit 322 on the second path, so that both the first frequency conversion circuit 312 on the first path and the second frequency conversion circuit 322 on the second path operate on the first channel.

Alternatively, when the target channel is the second channel, the radio frequency control circuit 63 controls, based on a frequency of the second channel indicated by the first notification, a second phase-locked loop circuit 332 to output a local oscillator signal to both a first frequency conversion circuit 312 on the first path and a second frequency conversion circuit 322 on the second path. In this case, the second phase-locked loop circuit 332 is connected to both the first frequency conversion circuit 312 on the first path and the second frequency conversion circuit 322 on the second path, so that both the first frequency conversion circuit 312 on the first path and the second frequency conversion circuit 322 on the second path operate on the second channel.

Therefore, the radio frequency control circuit 63 may configure both the first frequency conversion circuit 312 on the first path and the second frequency conversion circuit 322 on the second path to operate on the target channel.

S404: A first antenna and a second antenna send a clear to send control frame to the another terminal device on the target channel, and after sending the clear to send control frame, receive, on the target channel, a service packet sent by the another terminal device.

The clear to send control frame is represented by using a CTS control frame 4.

When receiving the RTS control frame 4, the terminal device 1 may determine whether the terminal device 1 allows the another terminal device to send another service packet to the terminal device 1.

If the terminal device 1 allows the another terminal device to send the another service packet to the terminal device 1, the terminal device 1 may send, to the another terminal device on the target channel, the CTS control frame 4 corresponding to the RTS control frame 4. Correspondingly, the another terminal device may receive the CTS control frame 4 on the target channel. When receiving the CTS control frame 4, the another terminal device may determine that the terminal device 1 allows the another terminal device to send the another service packet to the terminal device 1.

Therefore, the another terminal device may send the another service packet to the terminal device 1 on the target channel.

If the terminal device 1 does not allow the another terminal device to send the another service packet to the terminal device 1, the terminal device 1 may discard the RTS control frame 4. Correspondingly, the another terminal device cannot receive the CTS control frame 4 on the target channel.

Therefore, the another terminal device cannot send the another service packet to the terminal device 1. In this case, the another terminal device may continue to attempt to send the RTS control frame 4 to the terminal device 1, or may abandon sending the another service packet to the terminal device 1.

The CTS control frame 4 indicates that the terminal device 1 allows the another terminal device to send the another service packet on the target channel. A specific implementation of the CTS control frame 4 is not limited in this disclosure.

On the first path, the CTS control frame 4 is processed by a baseband sending circuit 61, a first DAC 43, the first frequency conversion circuit 312, and a first radio frequency front end circuit 311, and a signal is transmitted through the first antenna 10.

On the second path, the CTS control frame 4 is processed by the baseband sending circuit 61, a second DAC 44, the second frequency conversion circuit 322, and a second radio frequency front end circuit 321, and a signal is transmitted through the second antenna 20.

Therefore, the terminal device 1 may separately send the CTS control frame 4 to the another terminal device on the target channel through the first antenna 10 on the first path and the second antenna 20 on the second path, so that the another terminal device learns, based on the CTS control frame 4, that the terminal device 1 needs to receive the service packet on the target channel.

When receiving the CTS control frame 4, the another terminal device may send the service packet to the terminal device 1 on the target channel. Therefore, the terminal device 1 may receive the service packet from the another terminal device on the target channel through the first antenna 10 on the first path and the second antenna 20 on the second path.

In a specific implementation, with reference to FIG. 13, a specific implementation process in which the terminal device 1 sends a service packet to the terminal device 2 is described in detail by using an example in which the terminal device 1 is a STA, a Wi-Fi P2P connection between the terminal device 1 and the terminal device 2 is link1, and a Wi-Fi P2P connection between the terminal device 1 and the terminal device 2 is link2.

FIG. 13 is a diagram of a service packet transmission scenario of a terminal device according to an embodiment of this disclosure.

As shown in FIG. 13, the P2P communication method in this disclosure may include the following steps.

Step 31: A first path in a STA performs monitoring on link1 and starts a BO counter to perform counting, and a second path in the STA performs monitoring on link2 and starts a BO counter to perform counting.

A channel on link1 is a first channel, and a channel on link2 is a second channel.

The BO counter may count down starting from a random number. A specific value of the random number is not limited in this disclosure. For ease of description, in FIG. 13, an example in which the BO counter counts down starting from 2 is used for illustration.

Step 32: In a counting process of the BO counter (in FIG. 13, timing to 1 is used for illustration), the STA determines that an RTS control frame 4 is received on link1, and may parse the RTS control frame 4, and compare whether a destination address of a service packet points to the STA.

Step 33: In a process of processing the RTS control frame 4, even if counting of the BO counter on link2 expires, the STA still needs to wait, and cannot trigger sending of a service packet.

Step 34: When determining that the destination address points to the STA, the STA may determine that the STA needs to receive a service packet sent by another terminal device. The another terminal device herein may be a terminal device 2, that is, the RTS control frame 4 is sent by the terminal device 2 to a terminal device 1. Alternatively, the another terminal device herein may be a terminal device 3 instead of the terminal device 2, that is, the RTS control frame 4 is sent by the terminal device 3 to the terminal device 1.

For ease of description, an example in which the RTS control frame 4 is sent by the terminal device 2 to the terminal device 1 is used for illustration.

Therefore, the first path in the STA determines that a service packet sent by the terminal device 2 is received on link1, and simultaneously configures, through a first phase-locked loop circuit 331, a second frequency conversion circuit 322 on the second path to perform channel switching, that is, switch the channel on link2 from the second channel to the first channel. In addition, the channel on link1 is kept as the first channel.

Step 35: The STA sends a CTS control frame 4, receives a PPDU, and sends an ACK control frame 4 on link1 and link2. The ACK control frame 4 is an acknowledgment control frame sent by the terminal device 1 to the terminal device 2.

Step 36: After sending the ACK control frame 4, the STA configures, through a second phase-locked loop circuit 332, a second frequency conversion circuit 322 on the second path to perform channel switching, that is, switch the channel on link2 from the first channel to the second channel. In addition, the channel on link1 is kept as the first channel. In this way, subsequent channel monitoring is facilitated.

Step 37: The first path in the STA continues to perform monitoring on link1 and starts the BO counter to perform counting, that is, the BO counter may start counting down following the counting in step 32. For ease of description, in FIG. 13, an example in which the BO counter continues to count down starting from 0 is used for illustration.

After the channel of the second path in the STA on link2 is switched from the first channel to the second channel, the STA needs to keep monitoring the second channel on link2 for a period of time (medium sync delay), to resume virtual carrier monitoring on the second channel. Therefore, the second path in the STA continues to perform monitoring on link2 and starts the BO counter to perform counting (not shown in FIG. 13).

Further, the STA may send a service packet to the another terminal device in the manner shown in FIG. 8A, FIG. 8B, and FIG. 9, or in the manner shown in FIG. 10A, FIG. 10B, and FIG. 11. If a case in which the first RTS control frame in S301 may point to the terminal device still occurs, the STA may first receive, in the manner shown in FIG. 12A, FIG. 12B, and FIG. 13, the service packet sent by the another terminal device.

Based on the descriptions of the embodiments in FIG. 12A, FIG. 12B, and FIG. 13, in the service packet transmission scenario, the single radio frequency multi-link control circuit 53 may detect whether the another terminal device sends the service packet on the first channel and/or the second channel. When the another terminal device sends the service packet to the terminal device 1, the single radio frequency multi-link control circuit 53 uses a channel for a request sent by the another terminal device as the target channel. The single radio frequency multi-link control circuit 53 may configure the two frequency conversion circuits and control the switching switch 51 to configure both the first antenna 10 and the second antenna 20 to operate on the target channel. Therefore, the terminal device 1 may receive, on the target channel through the first antenna 10 and the second antenna 20, the service packet sent to the another terminal device, so that sending and receiving of the 2×2 MIMO capability can be implemented.

Finally, it should be noted that the foregoing embodiments are merely specific implementations of this disclosure, but are not intended to limit the protection scope of this disclosure. Any variation or replacement within the technical scope disclosed in this disclosure shall fall within the protection scope of this disclosure. Therefore, the protection scope of this disclosure shall be subject to the protection scope of the claims.

What is claimed is:

1. A terminal device comprising:
a first antenna;
a second antenna;
a baseband receiving circuit;
a radio frequency circuit coupled to the first antenna and the baseband receiving circuit, wherein the first antenna, the radio frequency circuit, and the baseband receiving circuit define a first path;
a channel monitoring and switching circuit coupled to the second antenna and the radio frequency circuit, wherein the second antenna, the radio frequency circuit, and the channel monitoring and switching circuit define a second path, and wherein the channel monitoring and switching circuit is further coupled to the baseband receiving circuit; and
a radio frequency control circuit coupled to the radio frequency circuit and the channel monitoring and switching circuit, wherein the radio frequency control circuit is configured to, through the radio frequency circuit, configure the first path to operate on a first channel and the second path to operate on a second channel;
wherein the baseband receiving circuit is configured to:
monitor the first channel to obtain first monitoring information; and
send the first monitoring information to the channel monitoring and switching circuit;
wherein the channel monitoring and switching circuit is further configured to:
monitor the second channel to obtain second monitoring information;
establish, when a service packet is to be transmitted, a connection between the radio frequency circuit and the baseband receiving circuit on the second path based on the first monitoring information and the second monitoring information; and
send a first notification to the radio frequency control circuit;
wherein the radio frequency control circuit is further configured to, based on the first notification through the radio frequency circuit, configure both the first path and the second path to operate on a target channel, and wherein the target channel is the first channel or the second channel; and
wherein the first antenna and the second antenna are configured to transmit a service packet on the target channel.

2. The terminal device of claim 1, wherein
the baseband receiving circuit is further configured to send a second notification to the channel monitoring and switching circuit when transmission of the service packet ends;
wherein the channel monitoring and switching circuit is further configured to:
break the connection between the radio frequency circuit and the baseband receiving circuit based on the second notification; and
send a third notification to the radio frequency control circuit; and
wherein the radio frequency control circuit is further configured to, based on the third notification through the radio frequency circuit, configure the first path to operate on the first channel and the second path to operate on the second channel.

3. The terminal device of claim 1, wherein the radio frequency control circuit is further configured to:
when the target channel is the first channel, configure the first path to continue to operate on the first channel, and configure the second path to switch to operate on the first channel; and
when the target channel is the second channel, configure the first path to switch to operate on the second channel, and configure the second path to continue to operate on the second channel.

4. The terminal device of claim 1, wherein
the channel monitoring and switching circuit is further configured to select a channel in an idle state as the target channel based on the first monitoring information and the second monitoring information;
wherein the first antenna or the second antenna corresponds to the target channel and is configured to send a first request-to-send (RTS) control frame on the target channel;
wherein the channel monitoring and switching circuit is further configured to establish the connection between the radio frequency circuit and the baseband receiving circuit on the second path, and send the first notification to the radio frequency control circuit;
wherein the radio frequency control circuit is further configured to, based on the first notification through the radio frequency circuit, configure both the first path and the second path to operate on the target channel; and
wherein the first antenna and the second antenna are further configured to, after the baseband receiving circuit receives a clear-to-send (CTS) control frame, send a service packet on the target channel.

5. The terminal device of claim 1, wherein
the channel monitoring and switching circuit is further configured to select a channel not configured to send a first request as a control channel to send a control frame when determining, based on the first monitoring information and the second monitoring information, that a received first RTS control frame does not point to the terminal device;
wherein the first antenna or the second antenna corresponds to the target channel and is further configured to send a second RTS control frame on the target channel;
wherein the channel monitoring and switching circuit is further configured to:
establish the connection between the radio frequency circuit and the baseband receiving circuit on the second path; and
send the first notification to the radio frequency control circuit;
wherein the radio frequency control circuit is configured to, based on the first notification through the radio frequency circuit, configure both the first path and the second path to operate on the target channel; and
wherein the first antenna and the second antenna are configured to send a service packet on the target channel after the baseband receiving circuit receives a clear to send control frame.

6. The terminal device of claim 4, wherein
the channel monitoring and switching circuit is further configured to select the target channel for the first RTS control frame when, based on the first monitoring information and the second monitoring information, the first RTS control frame points to the terminal device;
wherein the channel monitoring and switching circuit is further configured to:
establish the connection between the radio frequency circuit and the baseband receiving circuit on the second path; and
send the first notification to the radio frequency control circuit;
wherein the radio frequency control circuit is further configured to, based on the first notification through the radio frequency circuit, configure both the first path and the second path to operate on the target channel; and
wherein the first antenna and the second antenna are configured to:
send a CTS control frame on the target channel; and
receive, on the target channel, a service packet after sending the CTS control frame.

7. The terminal device of claim 1, further comprising:
a first analog-to-digital converter (ADC);
a second ADC;
a first digital-to-analog converter (DAC);
a second DAC; and
a baseband sending circuit, wherein
the radio frequency circuit is further coupled to the first ADC and the first DAC on the first path and is further coupled to the second ADC and the second DAC on the second path, wherein the first ADC is coupled to the baseband receiving circuit, wherein the second ADC is coupled to the channel monitoring and switching circuit, wherein the channel monitoring and switching circuit is further coupled to the baseband sending circuit, and wherein the baseband sending circuit is further coupled to the first DAC and the second DAC.

8. The terminal device of claim 7, wherein the channel monitoring and switching circuit comprises:
a monitoring circuit comprising a first end and a second end;
a single radio frequency multi-link control circuit comprising a third end and a fourth end;
a switch comprising:
a fifth end coupled to the second ADC;
a first contact point coupled to the baseband receiving circuit;
a second contact point coupled to the first end; and
a control end coupled to the third end;
wherein the second end of the monitoring circuit is coupled to the fourth end of the single radio frequency multi-link control circuit, a sixth end of the single radio frequency multi-link control circuit is coupled to the radio frequency control circuit, a seventh end of the single radio frequency multi-link control circuit is coupled to the baseband receiving circuit, and an eighth end of the single radio frequency multi-link control circuit is coupled to the baseband sending circuit;
wherein the single radio frequency multi-link control circuit is configured to control the switch to:
break the connection between the radio frequency circuit and the baseband receiving circuit on the second path; and
establish a connection between the radio frequency circuit and the monitoring circuit on the second path;
wherein the single radio frequency multi-link control circuit is further configured to receive the first monitoring information sent by the baseband receiving circuit;
wherein the monitoring circuit is configured to monitor the second channel, and send the second monitoring information to the single radio frequency multi-link control circuit;
wherein the single radio frequency multi-link control circuit is further configured to determine the target channel based on the first monitoring information and the second monitoring information; and
wherein the single radio frequency multi-link control circuit is further configured to control the switch to establish the connection between the radio frequency circuit and the baseband receiving circuit on the second path, break the connection between the radio frequency circuit and the monitoring circuit on the second path, and send the first notification to the radio frequency control circuit.

9. The terminal device of claim 8, wherein the single radio frequency multi-link control circuit is further configured to receive a second notification sent by the baseband receiving circuit, and wherein the single radio frequency multi-link control circuit is further configured to:
control, based on the second notification, the switch to break the connection between the radio frequency circuit and the baseband receiving circuit on the second path;
establish the connection between the radio frequency circuit and the monitoring circuit on the second path; and
send a third notification to the radio frequency control circuit, wherein the third notification is used by the radio frequency control circuit to configure, through the radio frequency circuit, the first path to operate on the first channel and the second path to operate on the second channel.

10. The terminal device of claim 8, wherein the radio frequency circuit comprises:
a first radio frequency front end circuit comprising:
a first common end coupled to the first antenna; and
a ninth end;
a first frequency conversion circuit comprising a tenth end coupled to the ninth end, wherein an eleventh end of the first frequency conversion circuit is coupled to a twelfth end of the first ADC, wherein a thirteenth end of the first ADC is coupled to a first end of the baseband receiving circuit, wherein a fourteenth end of the baseband sending circuit is coupled to the thirteenth end of the first DAC, and wherein a fifteenth end of the first DAC is connected to a sixteenth end of the first frequency conversion circuit;
a first phase-locked loop circuit comprising a seventeenth end coupled to an eighteenth end of the first frequency conversion circuit;
a second phase-locked loop circuit comprising a nineteenth end coupled to a twentieth end of the first frequency conversion circuit, wherein a twenty-first end of the first phase-locked loop circuit is coupled to a twenty-second end of the radio frequency control circuit;
a second radio frequency front end circuit comprising:
a second common end coupled to the second antenna; and
a twenty-third end; and
a second frequency conversion circuit comprising a twenty-fourth end coupled to the twenty-third end, wherein
a twenty-fifth end of the second frequency conversion circuit is coupled to a twenty-sixth end of the second ADC, wherein a twenty-seventh end of the second ADC is coupled to the fifth end, wherein a twenty-eighth end of the baseband sending circuit is coupled to a twenty-ninth end of the second DAC, wherein a thirtieth end of the second DAC is coupled to a thirty-first end of the second frequency conversion circuit, wherein a thirty-second end of the second frequency conversion circuit is coupled to a thirty-third end of the second phase-locked loop circuit, wherein a thirty-fourth end of the second frequency conversion circuit is coupled to the seventeenth end of the first phase-locked loop circuit, wherein a thirty fifth end of the second phase-locked loop circuit is coupled to a thirty-fifth end of the radio frequency control circuit, wherein the first contact point of the switch is coupled to a thirty-sixth end of the baseband receiving circuit, wherein the seventh end of the single radio frequency multi-link control circuit is coupled to a thirty-seventh end of the baseband receiving circuit, and wherein the eighth end of the single radio frequency multi-link control circuit is coupled to a thirty-ninth end of the baseband sending circuit.

11. The terminal device of claim 1, wherein the first channel and the second channel are in different bands.

12. The terminal device of claim 11, wherein the first channel and the second channel are any one of a channel in a 2.4 gigahertz (G) band and a channel in the 2.4G band, a channel in a 5G band and a channel in the 5G band, a channel in a 6G band and a channel in the 6G band, a channel in a 2.4G band and a channel in a 5G band, a channel in a 2.4G band and a channel in a 6G band, or a channel in a 5G band and a channel in a 6G band.

13. A peer-to-peer communication method comprising:
configuring a first path to operate on a first channel and a second path to operate on a second channel;
monitoring the first channel to obtain first monitoring information;
monitoring the second channel to obtain second monitoring information;
establishing, when a service packet is to be transmitted, a connection on the second path based on the first monitoring information and the second monitoring information;
sending a first notification;
configuring, based on the first notification, both the first path and the second path to operate on a target channel, wherein the target channel is the first channel or the second channel; and
transmitting a service packet on the target channel.

14. The method of claim 13, further comprising:
sending a second notification when transmission of the service packet ends;
breaking the connection on the second path based on the second notification;
sending a third notification; and
configuring, based on the third notification, the first path to operate on the first channel and the second path to operate on the second channel.

15. The method of claim 13, further comprising:
selecting a channel in an idle state as the target channel based on the first monitoring information and the second monitoring information;
sending a request-to-send (RTS) control frame on the target channel;
establishing the connection on the second path, and sending the first notification;
configuring, based on the first notification, both the first path and the second path to operate on the target channel; and
after receiving a clear-to-send (CTS) control frame, sending a service packet on the target channel.

16. The method of claim 13, further comprising:
when determining, based on the first monitoring information and the second monitoring information, that a received first RTS control frame does not point to a terminal device, selecting a channel other than a channel for the first RTS control frame in the first channel and the second channel as the target channel;
sending a second RTS control frame on the target channel;
establishing the connection on the second path, and sending the first notification;
configuring, based on the first notification, both the first path and the second path to operate on the target channel; and
after receiving a CTS control frame, sending a service packet on the target channel.

17. The method of claim 16, further comprising:
when determining, based on the first monitoring information and the second monitoring information, that the received RTS control frame points to a receiving device, selecting a channel for the RTS control frame as the target channel;
establishing the connection on the second path, and sending the first notification;
configuring, based on the first notification, both the first path and the second path to operate on the target channel; and
sending a CTS control frame on the target channel, and after sending the CTS control frame, receiving, on the target channel, a service packet.

18. The method of claim 16, further comprising:
when determining, based on the first monitoring information and the second monitoring information, that the received RTS control frame points to a receiving device, selecting a channel for the RTS control frame as the target channel;
establishing the connection on the second path, and sending, by a channel monitoring and switching circuit, the first notification to a radio frequency control circuit;
configuring, based on the first notification, both the first path and the second path to operate on the target channel; and
sending a CTS control frame on the target channel, and after sending the CTS control frame, receiving, on the target channel, a service packet.

19. A computer program product comprising instructions stored on a non-transitory medium and that, when executed by one or more processors, cause a terminal device to:
configure a first path to operate on a first channel and a second path to operate on a second channel;
monitor the first channel to obtain first monitoring information;
monitor the second channel to obtain second monitoring information;
establish, when a service packet is to be transmitted, a connection on the second path based on the first monitoring information and the second monitoring information;
send a first notification;
configure, based on the first notification, both the first path and the second path to operate on a target channel, wherein the target channel is the first channel or the second channel; and
transmit a service packet on the target channel.

20. The computer program product of claim 19, wherein the instructions further cause the terminal device to:
send a second notification when transmission of the service packet ends;
break the connection on the second path based on the second notification;
send a third notification; and
configure, based on the third notification, the first path to operate on the first channel and the second path to operate on the second channel.
